(19) United States
(12) Patent Application Publication
(10) Pub. No.: US 2025/0001803 A1
(43) Pub. Date: Jan. 2, 2025

(54) TIRE

(71) Applicant: The Yokohama Rubber Co., LTD., Kanagawa (JP)

(72) Inventors: Ryo YOSHIE, Kanagawa (JP); Hiroshi HATA, Kanagawa (JP)

(21) Appl. No.: 18/710,844

(22) PCT Filed: Nov. 4, 2022
(86) PCT No.: PCT/JP2022/041253

§ 371 Date: May 16, 2024

(30) Foreign Application Priority Data
Nov. 24, 2021 (JP) 2021-190524

(51) Int. Cl. B60C 5/14; B60C 19/08

(52) U.S. Cl. CPC B60C 5/14; B60C 19/08

(57) ABSTRACT

A pneumatic tire includes: a pair of bead portions; at least one carcass layer extending between the pair of bead portions; a belt layer disposed on an outer side of the carcass layer in a tire radial direction; and a carcass inner rubber layer disposed on a tire inner cavity side with respect to the carcass layer. The pneumatic tire further includes a linear conductive portion extending continuously at least from one of the bead portions to the belt layer and disposed on the carcass inner rubber layer. The linear conductive portion is at least partially positioned in the carcass inner rubber layer and has a volume resistivity of less than 1×10\hat{ }8 Ω·cm.

### TECHNICAL FIELD

The present technology relates to a tire.

### BACKGROUND ART

Demand for a fuel-efficient tire has recently been increased due to environmental concerns. A used technique for making a tire fuel-efficient is a technique of suppressing tire rolling resistance by blending silica in a rubber used for a tread portion and a side portion of a tire. However, because silica has high insulating characteristics, the electrical resistance value of a tread rubber increases when silica content of the tread rubber increases, decreasing the electrostatic suppression performance of the tire. Decreasing the electrostatic suppression performance of the tire tends to accumulate static electricity generated during traveling of the vehicle, thus causing electromagnetic interference such as radio noise to tend to occur.

In response to this, some known pneumatic tires include a conductive member having a low electrical resistance value to increase electrostatic suppression performance to easily discharge static electricity generated in the vehicle during traveling of the vehicle to a road surface. For example, Japan Unexamined Patent Publication No. 2014-133467 A makes electrical resistance of a tire small by disposing a conductive thread having a small electrical resistance and extending in a toroidal shape between a pair of bead cores along a carcass ply.

However, in a case where a conductive fiber, such as a conductive thread, is disposed along a carcass ply, the electrical resistance of a tire in new condition is low, but the conductive fiber tends to rub against the carcass ply due to deformation of the tire during traveling of the vehicle to which the tire is installed. In this case, the conductive fiber may be broken due to repeated rubbing against the carcass ply, and electricity may not flow through the conductive fiber. In a case where the electricity cannot flow through conductive fiber due to breakage of the conductive fiber, tire electrical resistance tends to increase, electrostatic suppression performance of the tire decreases, and thus there has been room for improvement from the viewpoint of maintenance of tire electrical resistance after travel.

### SUMMARY

The present technology provides a tire that can maintain tire electrical resistance after travel.

A tire according to an embodiment of the present technology includes:
a pair of bead portions;
at least one carcass layer extending between the pair of bead portions;
a belt layer disposed on an outer side of the carcass layer in a tire radial direction; and
a carcass inner rubber layer disposed on a tire inner cavity side with respect to the carcass layer.

The tire further includes a linear conductive portion extending continuously at least from one of the bead portions to the belt layer and disposed on the carcass inner rubber layer.

The linear conductive portion is at least partially positioned in the carcass inner rubber layer and has a volume resistivity of less than 1×10\hat{ }8 Ω·cm.

In the tire, the belt layer preferably includes one or more belt plies extending in a tire width direction, and in drawing perpendicular lines from end portions on both sides in the tire width direction of a belt ply having a largest width in the tire width direction toward the tire inner surface, a periphery length between intersection points of the perpendicular lines and the tire inner surface is Lbp, a length in a periphery direction of a portion of the linear conductive portion positioned on an inner side in the tire radial direction of the belt layer is La, and the linear conductive portion preferably satisfies 0.01≤La/Lbp≤1.

In the tire, the linear conductive portion preferably has a relationship between a thickness t of the carcass inner rubber layer and a distance t1 from the tire inner surface in a portion of the linear conductive portion having a shortest distance from the tire inner surface in at least a region on the outer side in the tire radial direction from the bead portion satisfying 0.2≤t1/t≤0.8.

In the tire, preferably, a bead portion rubber in contact with a rim flange is disposed in the bead portion, the bead portion rubber has a volume resistivity of less than 1×10\hat{ }8 Ω·cm, and the linear conductive portion includes a portion overlapping the bead portion rubber.

In the tire, preferably, the linear conductive portion extends from the tire inner surface side to beyond a bead toe of the bead portion at least to a bead base and is in contact with the bead portion rubber at a position on the bead base side from the bead toe.

In the tire, the linear conductive portion preferably extends along the periphery direction in at least a region between the belt layer and the bead portion.

In the tire, the portion positioned on an inner side in the tire radial direction of the belt layer and a portion of the linear conductive portion positioned in the bead portion each preferably include a portion inclining at an inclination angle of 30° or less in the tire circumferential direction with respect to the periphery direction.

In the tire, the carcass inner rubber layer preferably includes a first layer and a second layer that are layered, and at least a part of the linear conductive portion is preferably disposed between the first layer and the second layer.

In the tire, the first layer is preferably an innerliner, and the second layer is preferably a tie rubber.

In the tire, the linear conductive portion is preferably sewn into the tie rubber.

In the tire, the linear conductive portion is preferably sewn into the tie rubber, and a length of 1 mm or more and 30 mm or less of the linear conductive portion is preferably exposed on a surface of the tie rubber.

In the tire, the linear conductive portion is preferably made by intertwining a plurality of linear members including at least one conductive linear member having a volume resistivity of less than 1×10\hat{ }8 Ω·cm.

In the tire, the linear conductive portion is preferably made by intertwining the conductive linear member and a non-conductive linear member having a volume resistivity of 19×10\hat{ }8 Ω·cm or more.

In the tire, the conductive linear member is preferably a metal fiber, and the non-conductive linear member is preferably an organic fiber.

In the tire, the conductive linear member is preferably made by intertwining a plurality of carbon fibers.

In the tire, the conductive linear member is preferably a monofilament cord made of carbon fiber.

In the tire, the linear conductive portion preferably has a total fineness of 20 dtex or more and 1000 dtex or less.

In the tire, the linear conductive portion preferably has an elongation ratio of 1.0% or more and 70.0% or less.

The tire according to an embodiment of the present technology has the effect of maintaining tire electrical resistance after travel.

### BRIEF DESCRIPTION OF DRAWINGS

FIG. 1 is a cross-sectional view in a tire meridian direction illustrating a pneumatic tire according to a first embodiment.

FIG. 2 is a detailed view illustrating a region in one side from a tire equatorial plane in a tire width direction in FIG. 1.

FIG. 3 is an explanatory diagram for a lap width of a linear conductive portion with respect to a belt layer.

FIG. 4 is a detailed view of a portion A of FIG. 2.

FIG. 5 is a detailed view of a portion B of FIG. 4.

FIG. 6 is a C-C cross-sectional view of FIG. 5.

FIG. 7 is a schematic diagram illustrating a form of arrangement of linear conductive portions in a case where a pneumatic tire is seen from a direction of a tire rotation axis.

FIG. 8 is an explanatory diagram for a single linear conductive portion.

FIG. 9 is a cross-sectional view of a main portion illustrating an arrangement configuration of a linear conductive portion in a pneumatic tire according to a second embodiment.

FIG. 10 is a D-D cross-sectional view of FIG. 9.

FIG. 11 is a modified example of a pneumatic tire according to the first embodiment and is an explanatory diagram illustrating a case where a carcass inner rubber layer and a linear conductive portion are positioned on an inner side in the tire width direction of a bead portion rubber.

FIG. 12 is a modified example of a pneumatic tire according to the first embodiment and is an explanatory diagram in a case where a linear conductive portion is also disposed on a bead base side.

FIG. 13 is a modified example of a pneumatic tire according to the first embodiment and is an explanatory diagram in a case where a conductive rubber is disposed in a bead portion rubber.

FIG. 14 is a modified example of a pneumatic tire according to the first embodiment and is an explanatory diagram in a case where a linear conductive portion is in contact with a chafer of a bead portion rubber.

FIG. 15 is a modified example of a pneumatic tire according to the first embodiment and is an explanatory diagram in a case where a linear conductive portion is in contact with a chafer of a bead portion rubber.

FIG. 16 is a modified example of a pneumatic tire according to the first embodiment and is an explanatory diagram in a case where a linear conductive portion includes a portion inclining with respect to a periphery direction.

FIG. 17 is a modified example of a pneumatic tire according to the second embodiment and is an explanatory diagram in a case where a linear conductive portion is sewn into a tie rubber while the linear conductive portion is inclining in tire circumferential direction.

FIG. 18 is a modified example of a pneumatic tire according to the second embodiment and is an explanatory diagram in a case where a linear conductive portion is braided into a tie rubber.

FIG. 19 is a modified example of a pneumatic tire according to the second embodiment and is an explanatory diagram in a case where a linear conductive portion is sewn into a tie rubber by also using a linear non-conductive portion.

FIG. 20 is an explanatory diagram of a modified example of the pneumatic tire according to the first embodiment in a case where a carcass inner rubber layer includes a cover rubber layer.

FIG. 21 is a view in the direction of arrows E-E in FIG. 20.

FIG. 22 is a modified example of a pneumatic tire according to the first embodiment and is an explanatory diagram in a case where linear conductive portions are disposed on both sides in a tire width direction.

FIG. 23 is a modified example of a pneumatic tire according to the first embodiment and is an explanatory diagram in a case where linear conductive portions are disposed on both sides in a tire width direction.

FIG. 24 is a modified example of a pneumatic tire according to the first embodiment and is an explanatory diagram in a case where an earthing tread is disposed.

FIG. 25A is a table showing results of performance evaluation tests of pneumatic tires.

FIG. 25B is a table showing results of performance evaluation tests of pneumatic tires.

### DETAILED DESCRIPTION

Tires according to embodiments of the present technology will be described in detail below with reference to the drawings. However, the technology is not limited to the embodiment. Constituents of the following embodiments include elements that can be substituted and easily conceived of by a person skilled in the art or that are essentially identical.

### First Embodiment

### Pneumatic Tire

In the following description, a description will be given using a pneumatic tire 1 as an example of the tire according to the embodiments of the present technology. The pneumatic tire 1 as an example of the tire can be inflated with any gas including air and inert gas, such as nitrogen.

Hereinafter, the term “tire radial direction” refers to a direction orthogonal to a tire rotation axis (not illustrated) that is a rotation axis of the pneumatic tire 1, the term “inner side in a tire radial direction” refers to a side toward the tire rotation axis in the tire radial direction, and the term “outer side in the tire radial direction” refers to a side away from the tire rotation axis in the tire radial direction. The term “tire circumferential direction” refers to a circumferential direction with the tire rotation axis as a center axis. Additionally, the term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The tire width is the width in the tire width direction between portions located on the outermost sides in the tire width direction, or in other words, the distance between the portions that are the most distant from the tire equatorial plane CL in the tire width direction. “Tire equator line” refers to a line in the tire circumferential direction of the pneumatic tire 1 that lies on the tire equatorial plane CL. In the description below, “tire meridian section” refers to a cross-section of the tire taken along a plane that includes the tire rotation axis.

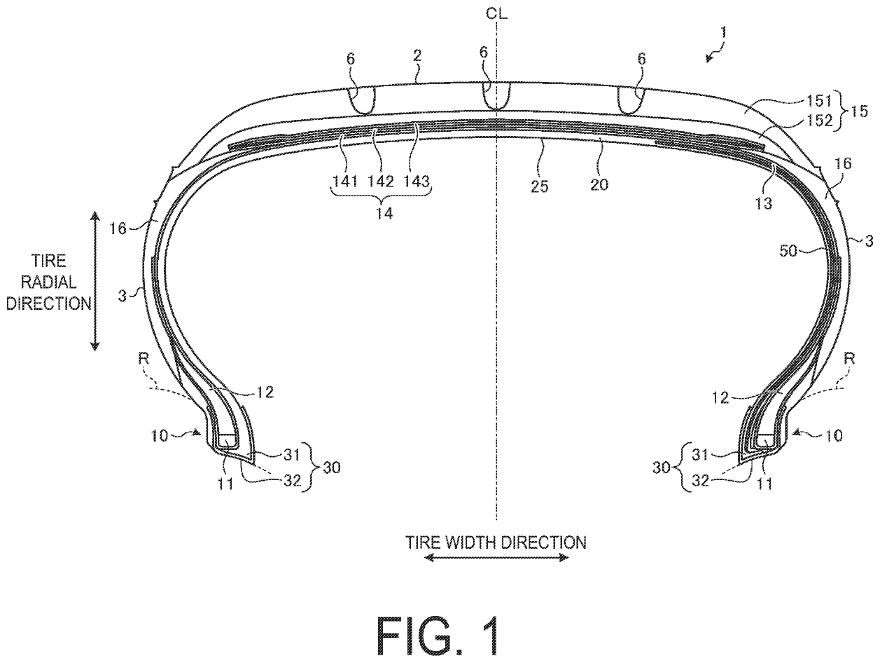

FIG. 1 is a cross-sectional view in a tire meridian direction illustrating a pneumatic tire 1 according to the first embodiment. The same drawing illustrates a half region in a tire radial direction. The same drawing also illustrates a radial tire for a passenger vehicle as an example of a pneumatic tire.

A pneumatic tire 1 according to the first embodiment has an annular structure having a tire rotation axis as a center, and includes a tread portion 2, a pair of sidewall portions 3, 3, a pair of bead portions 10, 10, a carcass layer 13, a belt layer 14, and a carcass inner rubber layer 20 (see FIG. 1). Among these, the pair of sidewall portions 3, 3 and the pair of bead portions 10, 10 are each disposed on both sides of the tire equatorial plane CL in the tire width direction.

The pair of bead portions 10, 10 is positioned on the inner side in the tire radial direction of the pair of the sidewall portions 3, 3 and each has a bead core 11, a bead filler 12, and a bead portion rubber 30. In other words, a pair of the bead cores 11, 11, a pair of the bead fillers 12, 12, and a pair of the bead portion rubbers 30, 30 are disposed on both sides of the tire equatorial plane CL in the tire width direction. Furthermore, the bead portion rubber 30 includes a rim cushion rubber 31 and a chafer 32. Because of this, on both sides of the tire equatorial plane CL in the tire width direction, a pair of the rim cushion rubbers 31, 31 and a pair of chafers 32, 32 are disposed.

The pair of bead cores 11, 11 is annular members made of a plurality of bead wires bundled together, and constitutes the cores of the pair of bead portions 10, 10. The pair of bead fillers 12, 12 are disposed on the outer side in the tire radial direction of the pair of bead cores 11, 11 to reinforce the bead portions 10.

The carcass layer 13 has a single layer structure made of one carcass ply or a multilayer structure made of a plurality of carcass plies, and spans between the bead portions 10, 10 positioned on both sides in the tire width direction in a toroidal shape to form a framework of the tire. The carcass ply of the carcass layer 13 is made by coating, with coating rubber, and rolling a plurality of carcass cords made from steel or an organic fiber material such as aramid, nylon, polyester, or rayon. For this carcass ply of the carcass layer 13, a carcass angle as an absolute value is within a range of 80 deg or more and 95 deg or less, the carcass angle being defined as an inclination angle of the carcass cord in the extension direction with respect to the tire circumferential direction.

In the first embodiment, the carcass layer 13 has a single layer structure and continuously extends between the bead cores 11, 11 on both sides in the tire width direction. Both end portions of the carcass layer 13 are turned back toward outer sides in the tire width direction and fixed to wrap the bead cores 11 and the bead fillers 12. In other words, both end portion regions of the carcass layer 13 in a cross-sectional view in the tire meridian direction extend through from the inner side in the tire width direction to the inner side in the tire radial direction of the bead cores 11 and the bead fillers 12 and are turned back toward outer sides in the tire width direction.

The carcass ply of the carcass layer 13 preferably has a value of tan δ at 60° C. of the coating rubber of the carcass cord of 0.20 or less, and the coating rubber of the carcass cord preferably has a volume resistivity of 1×10\hat{ }8 Ω·cm or more. Accordingly, the tire rolling resistance decreases. The coating rubber having such a volume resistivity is made, for example, by using a compound with low exothermic properties and low carbon content. Furthermore, the coating rubber may contain no silica or may be reinforced by blending silica.

The value of tan δ at 60° C. is measured using a viscoelasticity spectrometer available from Toyo Seiki Seisaku-sho, Ltd. under the following conditions: 10% initial distortion, ±0.5% amplitude, and 20 Hz frequency.

Furthermore, the volume resistivity (volume specific resistance) is measured in accordance with the method specified in JIS (Japanese Industrial Standard) K 6271 “Rubber, vulcanized or thermoplastic—Determination of volume resistivity and surface resistivity”. Typically, a member with a volume resistivity of less than 1×10\hat{ }8 Ω·cm or a surface resistivity of less than 1×10\hat{ }8 Ω/cm can be considered to have electrical conductivity sufficient to suppress a buildup of static electricity.

The pair of bead portion rubbers 30, 30 included in the pair of bead portions 10, 10 are disposed on an inner side in the tire radial direction of the turned back portions of the carcass layer 13 and the bead cores 11, 11 on both sides in the tire width direction. The bead portion rubber 30 is a portion in contact with a rim flange R included in a rim when the pneumatic tire 1 is mounted on the rim. The bead portion rubber 30 constitutes contact surfaces of the bead portions 10 for a rim flange R. The bead portion rubber 30 has a volume resistivity of less than 1×10\hat{ }8 Ω·cm. The volume resistivity of the bead portion rubber 30 is preferably 1×10\hat{ }8 Ω·cm or less.

The belt layer 14 has one or more belt plies extending in the tire width direction, and in the first embodiment, a plurality of belt plies 141 to 143 is layered. That is, in the first embodiment, the belt layer 14 is made by layering a pair of cross belts 141 and 142 and a belt cover 143 in the tire radial direction, and disposed on the outer side in the tire radial direction of the carcass layer 13 to wind around the outer circumference of the carcass layer 13. The pair of cross belts 141, 142 is made by covering a plurality of belt cords made from steel or an organic fiber material with coating rubber and performing a rolling process on it, and a belt angle defined as an inclination angle in extension directions of the belt cords with respect to the tire circumferential direction is within a range of 20 deg or more and 65 deg or less as an absolute value. The pair of cross belts 141, 142 is configured as a so-called crossply structure, by being layered with the extension directions of the belt cords intersecting with one another, with their belt angles having opposite signs. Thus, inclination directions of the belt cords of the pair of cross belts 141, 142, toward the tire width direction with respect to the tire circumferential direction, are opposite to each other. The belt cover 143 is made by performing a rolling process on coating-rubber-covered cords made of steel or an organic fiber material. The belt cover 143 has a belt angle, as an absolute value, within a range of 0 deg or more and 10 deg or less. The belt cover 143 is disposed layered on an outer side of the cross belts 141, 142 in the tire radial direction.

The tread portion 2 includes a tread rubber 15 that is a rubber composition and is disposed on an outer side of the carcass layer 13 and the belt layer 14 in the tire radial direction and is exposed on the outermost side of the pneumatic tire 1 in the tire radial direction. Because of this, the outer circumferential surface of the tread portion 2 constitutes part of contour of the pneumatic tire 1. On the tread portion 2, circumferential main grooves 6 extending in the tire circumferential direction and grooves such as lug grooves (not illustrated) are formed. The tread rubber 15 constituting the tread portion 2 includes a cap tread 151 and an undertread 152.

The cap tread 151 is a rubber member that is positioned on the outermost side of the tread portion 2 in the tire radial direction and that constitutes the tire ground contact surface and may have a single layer structure (see FIG. 1) or a multilayer structure (not illustrated). The cap tread 151 preferably has a value of tan δ at 60° C. of 0.25 or less. In addition, the cap tread 151 preferably has a volume resistivity of 1×10\hat{ }8 Ω·cm or greater, more preferably of 1×10\hat{ }10 Ω·cm or greater, and even more preferably of 1×10\hat{ }12 Ω·cm or greater. Accordingly, the rolling resistance of the pneumatic tire 1 is reduced. The cap tread 151 having such a volume resistivity is made using a compound with low exothermic properties and low carbon content, or alternatively by increasing the silica content to improve the volume resistivity.

The undertread 152 is a member layered inward of the cap tread 151 in the tire radial direction. The volume resistivity of the undertread 152 is preferably less than a volume resistivity of the cap tread 151.

The pair of the sidewall portions 3, 3 each includes a sidewall rubber 16. The pair of sidewall rubbers 16, 16 included in the pair of the sidewall portions 3, 3 are each disposed outward of the carcass layer 13 in the tire width direction. The sidewall rubber 16 preferably has a value of tan δ at 60° C. of 0.20 or less. In addition, the sidewall rubber 16 preferably has a volume resistivity of 1×10\hat{ }8 Ω·cm or more, more preferably of 1×10\hat{ }10 Ω·cm or more, and even more preferably of 1×10\hat{ }12 Ω·cm or more. Accordingly, the rolling resistance of the pneumatic tire 1 is reduced. The sidewall rubber 16 having such a volume resistivity is made using a compound with low exothermic properties and low carbon content, or alternatively by increasing the silica content to improve the volume resistivity.

The upper limit value for the volume resistivity of the cap tread 151, the lower limit value for the volume resistivity of the undertread 152, the upper limit value for the volume resistivity of the sidewall rubber 16, and the lower limit value for the volume resistivity of the rim cushion rubber 17 are not particularly limited, but are subject to physical restrictions specific to being a rubber member.

The carcass inner rubber layer 20 constitutes the tire inner surface 25 that is a surface on the inner side of the pneumatic tire 1, and the carcass inner rubber layer 20 is facing the tire inner cavity that is a space inside of the pneumatic tire 1. The carcass inner rubber layer 20 constituting the tire inner surface 25 is a rubber layer disposed on the tire inner cavity side with respect to the carcass layer 13 and covers the carcass layer 13 from the tire inner cavity side.

### Electrostatic Suppressing Structure

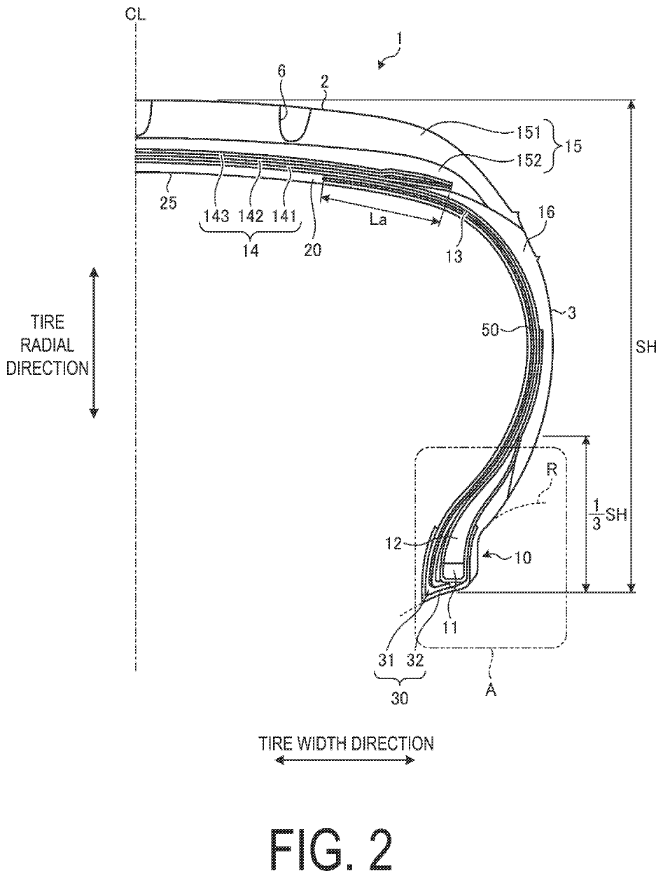

FIG. 2 is a detailed view illustrating a region in one side from a tire equatorial plane CL in a tire width direction in FIG. 1. The pneumatic tire 1 according to the first embodiment employs an electrostatic suppressing structure to discharge static electricity generated in the vehicle during traveling of the vehicle, to the road surface. As the electrostatic suppressing structure, a linear conductive portion 50 is used. The linear conductive portion 50 is a linear member having a volume resistivity of less than 1×10\hat{ }8 Ω·cm, extends continuously at least from the bead portion 10 to the belt layer 14, and is disposed on the carcass inner rubber layer 20. At least part of the linear conductive portion 50 disposed on the carcass inner rubber layer 20 is positioned in the carcass inner rubber layer 20. In the first embodiment, among the bead portions 10 disposed on both sides of the tire equatorial plane CL in the tire width direction, the linear conductive portion 50 is disposed continuously from one of the bead portions 10 to a position on the inner side of the belt layer 14 in the tire radial direction.

In the first embodiment, “bead portion 10” refers to the region from the rim diameter measuring position to a position at one third of the tire cross-sectional height SH. “Tire cross-sectional height SH” is referred to as a half of the difference between the tire outer diameter and the rim diameter measured when the pneumatic tire 1 is mounted on a specified rim, inflated to the specified internal pressure, and in an unloaded state.

Here, “specified rim” refers to an “applicable rim” defined by the Japan Automobile Tyre Manufacturers Association (JATMA), a “Design Rim” defined by the Tire and Rim Association (TRA), or a “Measuring Rim” defined by the European Tyre and Rim Technical Organisation (ETRTO). Additionally, the specified internal pressure refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. Additionally, “specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO. However, in the case of JATMA, for a tire for a passenger vehicle, the specified internal pressure is an air pressure of 180 kPa, and the specified load is 88% of the maximum load capacity.

The linear conductive portion 50 is disposed along the carcass inner rubber layer 20 in the carcass inner rubber layer 20 positioned on the inner side of the carcass layer 13 in the tire radial direction at the position on the inner side of the belt layer 14 in the tire radial direction, and the end portion of the linear conductive portion 50 on the outer side of the tire direction is positioned at a portion on the inner side of the belt layer 14 in the tire radial direction. Accordingly, the linear conductive portion 50 is disposed overlapping the belt layer 14 in the tire radial direction at a position on the inner side of the belt layer 14 in the tire radial direction.

The linear conductive portion 50 is disposed along the carcass inner rubber layer 20 in the carcass inner rubber layer 20 positioned on the inner side of the carcass layer 13 in the tire width direction at the positions at the sidewall portion 3 and the bead portion 10. The end portion of the linear conductive portion 50 disposed in this manner on the inner side of the tire direction is positioned on the inner side of the bead portion 10 in the tire width direction. The portion of the linear conductive portion 50 positioned in the bead portion 10 is disposed overlapping the bead portion rubber 30 in the tire width direction. Accordingly, a conductive path is ensured from the rim fitting surface to the linear conductive portion 50 via the bead portion rubber 30, and a conductive path from the position in the bead portion 10 to the position in the belt layer 14 is ensured.

The linear conductive portion 50 disposed as described above extends in a direction close to the tire width direction at a position overlapping the belt layer 14 in the tire radial direction and extends in a direction close to the tire radial direction at a position in the sidewall portion 3 or the bead portion 10.

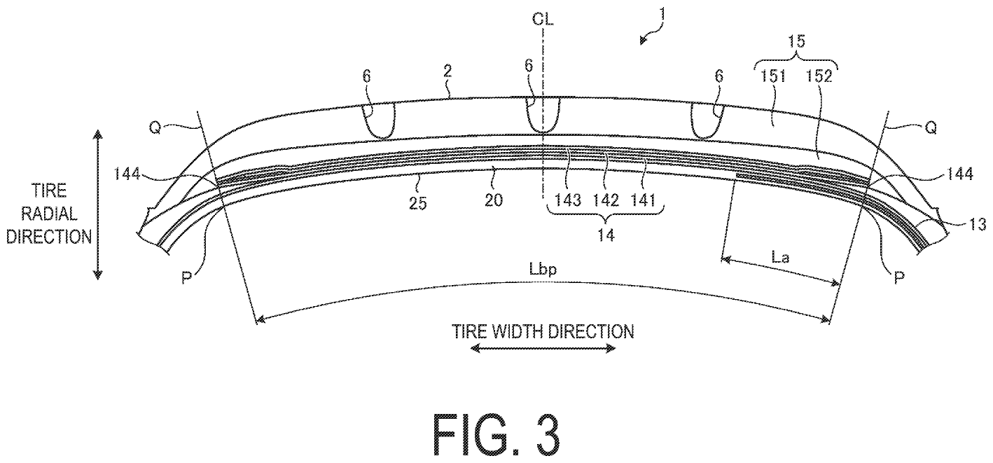

FIG. 3 is an explanatory diagram for a lap width La of a linear conductive portion 50 with respect to a belt layer 14. The linear conductive portion 50 has a relationship of a width Lbp of the belt layer 14 in the periphery direction and a width in the periphery direction of the portion of the linear conductive portion 50 overlapping the belt layer 14 in the tire radial direction, i.e., a lap width La of the linear conductive portion 50 with respect to the belt layer 14, satisfying 0.01≤La/Lbp≤1. The lap width La of the linear conductive portion 50 in this case is a distance La in the periphery direction of the portion of the linear conductive portion 50 positioned on the inner side of the belt layer 14 in the tire radial direction. In the first embodiment, the periphery direction refers to a direction along a surface of the pneumatic tire 1 at positions having an identical position in the tire circumferential direction.

The width Lbp of the belt layer 14 in the periphery direction in this case is a periphery length between intersection points P of perpendicular lines Q and a tire inner surface 25 when the perpendicular lines Q are drawn from end portions 144 on both sides in the tire width direction of the belt ply having a largest width in the tire width direction toward the tire inner surface 25. The lap width La of the linear conductive portion 50 with respect to the belt layer 14 is a length in the periphery direction of the portion of the linear conductive portion 50 positioned on the inner side of the belt layer 14 in the tire radial direction, specifically a length in the periphery direction of the portion of the linear conductive portion 50 positioned between the intersection points P.

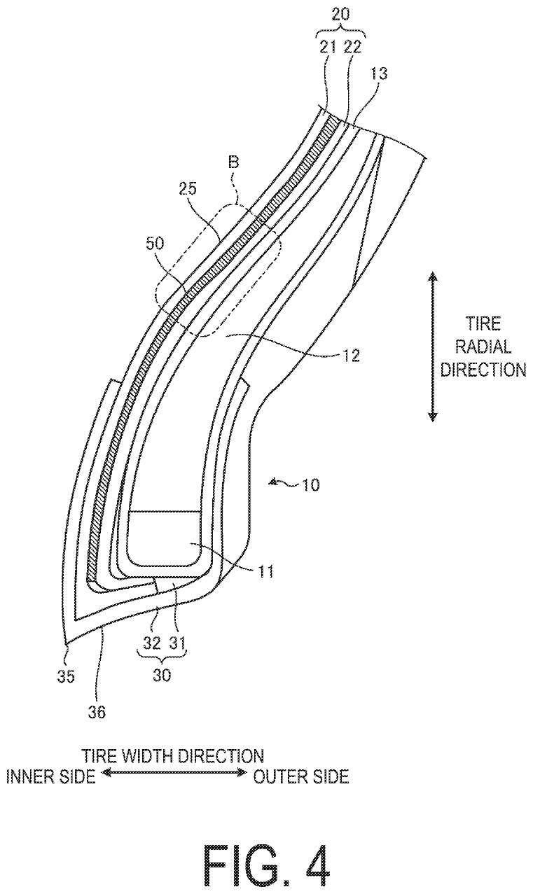

FIG. 4 is a detailed view of a portion A of FIG. 2. The carcass inner rubber layer 20 includes a first layer and a second layer that are layered, and at least part of the linear conductive portion 50 is disposed between the first layer and the second layer. In the first embodiment, the first layer of the carcass inner rubber layer 20 is an innerliner 21 constituting the tire inner surface 25 and the second layer is a tie rubber 22 disposed on a side where the carcass layer 13 is positioned with respect to the innerliner 21. Among these, the innerliner 21 is an air penetration preventing layer disposed covering the carcass layer 13, suppresses oxidation caused by exposure of the carcass layer 13, and prevents leaking of the air inflated in the tire. Additionally, the innerliner 21 is made of, for example, a rubber composition containing butyl rubber as a main component, a thermoplastic resin, and a thermoplastic elastomer composition containing an elastomer component blended in a thermoplastic resin. In particular, by using a thermoplastic resin or a thermoplastic elastomer composition to form the innerliner 21, the innerliner 21 can be made thinner than that in a configuration in which butyl rubber is used for the innerliner 21. Thus, the tire weight can be greatly reduced.

The air permeability coefficient of the innerliner 21 is typically preferably 100×10\hat{ }-12 [cc·cm/cm\hat{ }2·sec·cmHg] or less, and more preferably 50×10\hat{ }12 [cc·cm/cm\hat{ }2·sec·cmHg] or less, in a case where the air permeability coefficient is measured in accordance with JIS K 7126-1 at a temperature of 30° C. In addition, the innerliner 21 has a volume resistivity of preferably 1×10\hat{ }8 Ω·cm or more, and typically preferably 1×10\hat{ }9 Ω·cm or more.

Examples of the rubber composition containing butyl rubber as a main component that can be used include butyl rubber (IIR) and butyl-based rubber. Butyl-based rubber is preferably a halogenated butyl rubber such as chlorinated butyl rubber (Cl-IIR) and brominated butyl rubber (Br-IIR).

Examples of a thermoplastic resin that can be used include polyaamide resins (nylon 6 (N6), nylon 66 (N66), nylon 46 (N46), nylon 11 (N11), nylon 12 (N12), nylon 610 (N610), nylon 612 (N612), nylon 6/66 copolymers (N6/66), nylon 6/66/610 copolymers (N6/66/610), nylon MXD6, nylon 6T, nylon 9T, nylon 6/6T copolymers, nylon 66/PP copolymers, and nylon 66/PPS copolymers); polyester resins (aromatic polyesters such as polybutylene terephthalate (PBT), polyethylene terephthalate (PET), polyethylene isophthalate (PEI), polybutylene terephthalate/tetramethylene glycol copolymers, PET/PEI copolymers, polyarylate (PAR), polybutylene naphthalate (PBN), liquid crystal polyester, and polyoxyalkylene diimidic diacid/polybutylene terephthalate copolymers); polynitrile resins (polyacrylonitrile (PAN), polymethacrylonitrile, acrylonitrile/styrene copolymers (AS), (meth)acrylonitrile/styrene copolymers, and (meth)acrylonitrile/styrene/butadiene copolymers); poly(meth)acrylate resins (polymethylmethacrylate (PMMA), polyethylmethacrylate, ethylene ethyl acrylate copolymers (EEA), ethylene acrylate copolymers (EAA), and ethylene methyl acrylate resins (EMA)); polyvinyl resins (vinyl acetate (EVA), polyvinylalcohol (PVA), vinyl alcohol/ethylene copolymers (EVOH), polyvinylidene chloride (PVDC), polyvinyl chloride (PVC), vinyl chloride/vinylidene chloride copolymers, and vinylidene chloride/methylacrylate copolymers); cellulose resins (cellulose acetate and cellulose acetate butyrate); fluorine resins (polyvinylidene fluoride (PVDF), polyvinyl fluoride (PVF), polychlorofluoroethylene (PCTFE), and tetrafluoroethylene/ethylene copolymers (ETFE)); imide resins (aromatic polyimide (PI)); and the like.

Examples of elastomer that can be used include diene rubber and hydrogenates thereof (NR, IR, epoxidized natural rubber, SBR, BR (high-cis BR and low-cis BR), NBR, hydrogenated NBR, and hydrogenated SBR); olefin rubber (ethylene propylene rubber (EPDM, EPM), maleated ethylene propylene rubber (M-EPM); butyl rubber (IIR); isobutylene and aromatic vinyl or diene monomer copolymers; acrylic rubber (ACM); ionomer; halogen-containing rubber (Br-IIR, Cl-IIR, brominated copolymer of isobutylene/para-methyl styrene (Br-IPMS), chloroprene rubber (CR), hydrin rubber (CHC, CHR), chlorosulfonated polyethylene (CSM), chlorinated polyethylene (CM), and maleated chlorinated polyethylene (M-CM)); silicone rubber (methyl vinyl silicone rubber, di-methyl silicone rubber, and methyl phenyl vinyl silicone rubber); sulfur-containing rubber (polysulfide rubber); fluororubber (vinylidene fluoride rubber, fluorine-containing vinyl ether rubber, tetrafluoroethylene-propylene rubber, fluorine-containing silicone rubber, and fluorine-containing phosphazene rubber); and thermoplastic elastomer (styrene elastomer, olefin elastomer, polyester elastomer, urethane elastomer, and polyamide elastomer).

Furthermore, the tie rubber 22 disposed between the innerliner 21 and the carcass layer 13 is a layer to suppress penetration of the carcass cord of the carcass layer 13 into the innerliner 21 when an unvulcanized pneumatic tire 1 is inflated during tire manufacture. The tie rubber 22 contributes to air permeation preventive properties and steering stability on dry road surfaces for a pneumatic tire 1 after manufacture.

The bead portion rubber 30 disposed in the bead portion 10 is disposed extending on the outer side in the tire width direction of the bead core 11 through the inner side in the tire width direction of the bead core 11 in the bead portion 10 to the inner side in the tire radial direction of the bead core 11. The carcass inner rubber layer 20 is disposed from a position on the outer side in the tire width direction of a portion positioned on the inner side of the bead core 11 in the tire width direction at the chafer 32 in the bead portion rubber 30 to a position on the inner side of the bead core 11 in the tire radial direction, at a position in the bead portion 10. That is, the carcass inner rubber layer 20 extends beyond a position of the bead toe 35 that is an end portion on the inner side in the tire width direction of the bead base 36 that is an inner circumferential surface of the bead portion 10 to the bead base 36 side, in a position on the bead core 11 side with respect to the chafer 32.

The linear conductive portion 50 disposed in the carcass inner rubber layer 20 is positioned in the vicinity of the bead toe 35 on the outer side in the tire radial direction of the bead toe 35 at a position of the bead portion 10. Thus, the carcass inner rubber layer 20 and the linear conductive portion 50 overlap with the bead portion rubber 30 at a position in the bead portion 10.

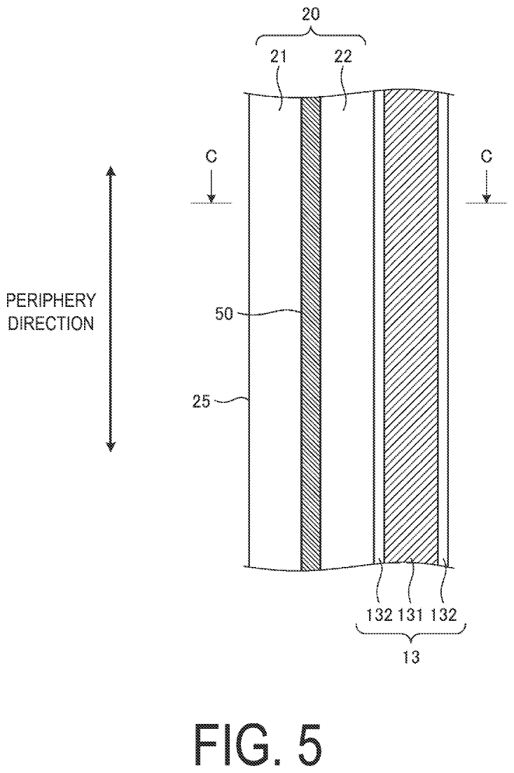

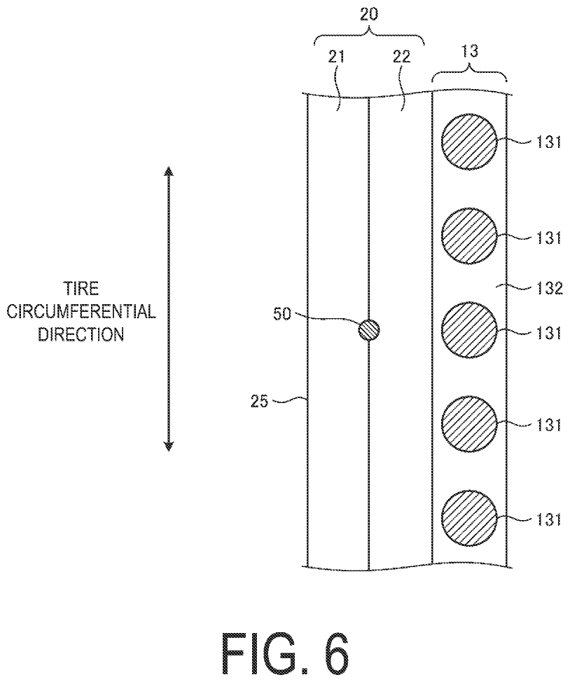

FIG. 5 is a detailed view of a portion B of FIG. 4. FIG. 6 is a C-C cross-sectional view of FIG. 5. The carcass layer 13 includes a plurality of carcass cords 131 and a coating rubber 132 covering the carcass cords 131, and the carcass cords 131 are inclining within a range of 80 deg or more and 95 deg or less in the tire circumferential direction. The linear conductive portion 50 disposed in the carcass inner rubber layer 20 is disposed between the innerliner 21 and the tie rubber 22 included in the carcass inner rubber layer 20 and is disposed along the carcass inner rubber layer 20. The linear conductive portion 50 extends along the periphery direction in at least a region between the belt layer 14 and the bead portion 10. That is, the linear conductive portion 50 is disposed in an orientation that makes the linear conductive portion 50 substantially parallel with the carcass cords 131 in a portion extending along the periphery direction.

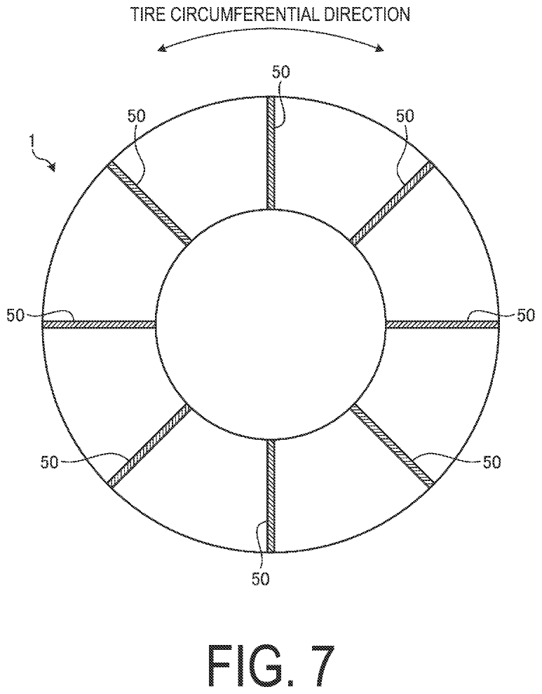

FIG. 7 is a schematic diagram illustrating a form of arrangement of linear conductive portions 50 in a case where a pneumatic tire 1 is seen from a direction of a tire rotation axis. In the pneumatic tire 1, a plurality of linear conductive portions 50 is disposed, and the plurality of the linear conductive portions 50 is disposed without overlapping each other. The plurality of the linear conductive portions 50 is, for example, disposed radially at predetermined intervals in the tire circumferential direction as illustrated in FIG. 7.

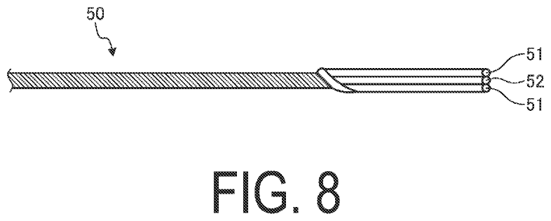

FIG. 8 is an explanatory diagram for a single linear conductive portion 50. FIG. 8 illustrates the stranded wire structure of the linear conductive portion 50. The linear conductive portion 50 has a linear structure including the conductive linear member 51. The linear conductive portion 50 preferably has a stranded wire structure made by intertwining a plurality of linear members including at least one conductive linear member 51 having a volume resistivity of less than 1×10\hat{ }8 Ω·cm. The linear conductive portion 50 may be a monofilament cord made of a conductive material (not illustrated).

The conductive linear member 51 is a linear member made of conductive material linearly formed. The conductive linear member 51 thus means a monofilament, a strand, or a cord made of conductive material. Accordingly, for example, the conductive linear member 51 may correspond to a monofilament cord made of a metal or carbon fiber, a metal fiber of fiberized metal such as stainless steel, and the like. Alternatively, the conductive linear member 51 may have a surface of a strand or cord that has been coated with a conductive material.

Examples of the stranded wire structure of the linear conductive portion 50 (see FIG. 8) include: (1) a structure made by intertwining a plurality of carbon fibers; and (2) a structure made by intertwining a conductive linear member 51 having a volume resistivity of less than 1×10\hat{ }8 Ω·cm and a non-conductive linear member 52 having a volume resistivity of 1×10\hat{ }8 Ω·cm or more. The stranded wire structure of the linear members is not limited to any particular structure, and any structure can be applied.

As the non-conductive linear member 52 of above-mentioned (2), for example, polyester fiber or nylon fiber can be used. In particular, the linear conductive portion 50 is preferably a blended yarn of the conductive linear member 51 made by intertwining a metal fiber and the non-conductive linear member 52 made of an organic fiber, such as polyester fiber.

The linear conductive portion 50 preferably has a total fineness within a range of 20 dtex or more and 1000 dtex or less, and more preferably within a range of 150 dtex or more and 350 dtex or less. Setting this lower limit of the total fineness to a value within the range described above ensures that the linear conductive portion 50 is prevented from breaking when the tire is manufactured. In addition, setting this upper limit of total fineness to a value within the range described above ensures that the linear conductive portion 50 is prevented from breaking during rolling of the tire.

The total fineness is measured in accordance with JIS L 1017 (8.3 Test methods for chemical fiber tire cords—Fineness based on corrected weight).

The elongation ratio of the linear conductive portion 50, that is, the elongation of the linear conductive portion 50, is preferably within a range of 1.0% or more and 70.0% or less. Setting the elongation to 1.0% or more ensures that the linear conductive portion 50 is prevented from breakage when the tire is manufactured. Setting the elongation to 70.0% or less ensures that the linear conductive portion 50 is prevented from breakage during rolling of the tire.

The elongation ratio of the linear members is measured in accordance with JIS L 1017 (8.5 Test methods for chemical fiber tire cords—Tensile strength and elongation ratio).

The linear conductive portion 50 of the first embodiment is yarn, and this linear conductive portion 50 is disposed between the carcass layer 13 and the adjacent member. As illustrated in FIG. 8, the linear conductive portion 50 has a stranded wire structure made by intertwining the conductive linear member 51 having a volume resistivity of less than 1×10\hat{ }8 Ω·cm and the non-conductive linear member 52 having a volume resistivity of 1×10\hat{ }8 Ω·cm or more.

In the pneumatic tire 1 according to the first embodiment, the electrostatic suppressing structure is configured as described above, and thus a path from the rim R through the bead portion rubber 30 and the linear conductive portion 50 to the belt layer 14 can be used as a conductive path to discharge static electricity in a vehicle to a road surface.

The bead portion rubber 30, the coating rubber of the carcass layer 13, and the coating rubber of the belt layer 14 constitute the conductive path from the rim R to the belt layer 14. Thus, the volume resistivities of these pieces of rubber are preferably set low. Accordingly, efficiency in the electrical conductivity from the rim R to the belt layer 14 is improved.

### Functions and Effects

When a vehicle on which the pneumatic tire 1 according to the first embodiment is mounted is driven, the pneumatic tire 1 rotates while, among surfaces of the tread portion 2 of the pneumatic tire 1, the portion located below and facing the road surface comes in contact with the road surface. The pneumatic tire 1 can cause a friction force between the road surface and the pneumatic tire by the surfaces of the tread portion 2 being successively brought into contact with the road surface as described above. By this, the vehicle can transmit driving force, braking force, and turning force to a road surface due to the friction force between the pneumatic tire 1 and the road surface and can be driven by the driving force, the braking force, and the turning force.

Static electricity may also be generated during traveling of a vehicle, and such static electricity flows from the rim R through the bead portion rubber 30 and the linear conductive portion 50 to the belt layer 14, then flows from the belt layer 14 to the tread rubber 15, and discharged from the tread rubber 15 to a road surface. Accordingly, the static electricity generated in the vehicle is discharged to the road surface, and electrostatic charge in the vehicle due to the static electricity is suppressed.

In other words, the linear conductive portion 50 having a volume resistivity of less than 1×10\hat{ }8 Ω·cm relatively facilitates flow of electricity and thus can reduce tire electrical resistance that is electrical resistance of the pneumatic tire 1. Accordingly, the pneumatic tire 1 including the linear conductive portion 50 can flow static electricity generated during traveling of a vehicle from the bead portion rubber 30 side to the belt layer 14 side through the linear conductive portion 50 and can suppress electrostatic charging of the vehicle due to static electricity.

Here, during traveling of the vehicle, the tread portion 2, the sidewall portion 3, and the like rotate while being deformed due to a load caused corresponding to the traveling condition of the vehicle. The linear conductive portion 50 is disposed on the tire inner cavity side with respect to the carcass layer 13. Thus, in a case where the tread portion 2 and the sidewall portion 3 are deformed, the carcass layer 13 is deformed along with the deformation, and thus the carcass layer 13 rubs the linear conductive portion 50, and the linear conductive portion 50 may be broken. For example, when the carcass layer 13 is deformed, because the carcass cords 131 included in the carcass layer 13 rub the linear conductive portion 50, the linear conductive portion 50 may be broken.

Because the conductive path from the rim R to the belt layer 14 is broken when the linear conductive portion 50 is broken, it becomes difficult for static electricity generated in the vehicle to be discharged to the road surface; however, in the pneumatic tire 1 according to the first embodiment, at least part of the linear conductive portion 50 is positioned in the carcass inner rubber layer 20. Because of this, even in a case where the tread portion 2 or the sidewall portion 3 is deformed, the linear conductive portion 50 is less likely to be rubbed by the carcass layer 13, and thus the conductive path between the bead portion rubber 30 and the belt layer 14 can be ensured by the linear conductive portion 50 even after the pneumatic tire 1 travels for a long distance. Accordingly, when the pneumatic tire 1 travels for a long distance, increase in the tire electrical resistance due to breakage of the linear conductive portion 50 can be suppressed. As a result, the tire electrical resistance after travel can be maintained.

The linear conductive portion 50 positioned at least partially in the carcass inner rubber layer 20 is preferably disposed without being exposed to the tire inner cavity side. That is, in a case where the linear conductive portion 50 is exposed from the carcass inner rubber layer 20 on the tire inner cavity side, the filled air may escape from the tire inner cavity side to the carcass layer 13 side through the linear conductive portion 50, and thus leakage of the air tends to occur. In this case, because the air pressure decreases, the amount of deformation of the tire during travel becomes larger, and thus the linear conductive portion 50 is less likely to be broken due to rubbing of the linear conductive portion 50 by the carcass inner rubber layer 20. When the linear conductive portion 50 is broken, the conductive path cannot be ensured by the linear conductive portion 50, the tire electrical resistance increases, and thus the linear conductive portion 50 is preferably disposed without exposure to the tire inner cavity side.

Because the linear conductive portion 50 has a relationship between the width Lbp of the belt layer 14 in the periphery direction and the lap width La of the linear conductive portion 50 with respect to the belt layer 14 satisfying 0.01≤La/Lbp≤1, the conductive path between the bead portion rubber 30 and the belt layer 14 can be reliably ensured by the linear conductive portion 50. In other words, in a case where the relationship between the width Lbp of the belt layer 14 and the lap width La of the linear conductive portion 50 with respect to the belt layer 14 is La/Lbp<0.01, because the lap width La of the linear conductive portion 50 with respect to the belt layer 14 is too small, it may be difficult to ensure adequate electrical conductivity between the linear conductive portion 50 and the belt layer 14. In this case, even if the linear conductive portion 50 is provided, it may be difficult to ensure the conductive path between the bead portion rubber 30 and the belt layer 14 and, as a result, it may be difficult to effectively reduce tire electrical resistance.

In contrast, in a case where the relationship between the width Lbp of the belt layer 14 and the lap width La of the linear conductive portion 50 with respect to the belt layer 14 satisfies 0.01≤La/Lbp≤1, adequate electrical conductivity between the linear conductive portion 50 and the belt layer 14 can be ensured, and the conductive path between the bead portion rubber 30 and the belt layer 14 can be reliably ensured by the linear conductive portion 50. As a result, tire electrical resistance can be reliably reduced by the linear conductive portion 50.

The bead portion rubber 30 has a volume resistivity of less than 1×10\hat{ }8 Ω·cm, and the linear conductive portion 50 is disposed with a portion overlapping the bead portion rubber 30. Accordingly, adequate electrical conductivity between the linear conductive portion 50 and the bead portion rubber 30 can be ensured, and the conductive path can be connected from the rim R to the linear conductive portion 50 through the bead portion rubber 30, and thus electricity can be more effectively passed. As a result, the tire electrical resistance of the pneumatic tire 1 in new condition can be reduced.

Because the linear conductive portion 50 extends along the periphery direction in at least a region between the belt layer 14 and the bead portion 10, the deformation of the sidewall portion 3 during travel can be prevented from acting as a shear force against the linear conductive portion 50. Accordingly, breakage of the linear conductive portion 50 due to action of shear force against the linear conductive portion 50 during travel can be suppressed, and the conductive path between the bead portion rubber 30 and the belt layer 14 can be more reliably ensured by the linear conductive portion 50 even after travel. As a result, the tire electrical resistance after travel can be more reliably maintained.

Because, in the carcass inner rubber layer 20, the innerliner 21 that is the first layer and the tie rubber 22 that is the second layer are layered, and at least part of the linear conductive portion 50 is disposed between the innerliner 21 and the tie rubber 22, when the tread portion 2 and the sidewall portion 3 are deformed, rubbing of the linear conductive portion 50 by the carcass cords 131 can be more reliably suppressed. Accordingly, the conductive path between the bead portion rubber 30 and the belt layer 14 can be more reliably ensured by the linear conductive portion 50 even after travel. As a result, the tire electrical resistance after travel can be more reliably maintained.

Because the linear conductive portion 50 is made by intertwining a plurality of linear members including at least one conductive linear member 51 having a volume resistivity of less than 1×10\hat{ }8 Ω·cm, strength of the linear conductive portion 50 can be ensured while a desired electric resistivity is ensured. That is, making the linear conductive portion 50 have a stranded wire structure having the plurality of linear members can improve strength against repeated fatigue and elongation compared to that of a structure in which the linear conductive portion 50 is a monofilament. As a result, the durability of the linear conductive portion 50 can be more reliably improved while tire electrical resistance is reduced.

Because the linear conductive portion 50 is made by intertwining a conductive linear member 51 and a non-conductive linear member 52 having a volume resistivity of 1×10\hat{ }8 Ω·cm or more, a weakness of the linear conductive portion 50 can be compensated by the non-conductive linear member 52 while a desired electric resistivity is ensured. As a result, strength, heat resistance, and dimensional stability of the linear conductive portion 50 can be appropriately ensured, and durability of the linear conductive portion 50 can be more reliably improved.

The linear conductive portion 50 can more reliably and appropriately have strength, heat resistance, and dimensional stability by making the 1 conductive linear member 51 a metal fiber and the non-conductive linear member 52 an organic fiber. As a result, the durability of the linear conductive portion 50 can be more reliably improved.

The linear conductive portion 50 can have strength while having a desired electric resistivity by forming the conductive linear member 51 by intertwining a plurality of carbon fibers. As a result, the durability of the linear conductive portion 50 can be more reliably improved while tire electrical resistance is reduced.

The linear conductive portion 50 can easily have a desired electric resistivity by forming the conductive linear member 51 of a monofilament cord containing a carbon fiber. As a result, reduction in the tire electrical resistance can be further easily attempted.

In addition, since the linear conductive portion 50 has the total fineness of 20 dtex or more and 1000 dtex or less, the total fineness of the linear conductive portion 50 can be properly set. In other words, when the total fineness of the linear conductive portion 50 is 20 dtex or more, breakage of the linear conductive portion 50 upon manufacture of the tire can be suppressed. Furthermore, when the total fineness of the linear conductive portion 50 is 1000 dtex or less, breakage of the linear conductive portion 50 during rolling of the tire can be suppressed.

Since the linear conductive portion 50 has an elongation ratio of 1.0% or more and 70.0% or less, the elongation ratio of the linear conductive portion 50 can be made proper. In other words, when the elongation ratio of the linear conductive portion 50 is 1.0% or more, breakage of the linear conductive portion 50 upon manufacture of the tire can be suppressed. Because the elongation ratio is 70.0% or less, breaking of the linear conductive portion 50 during rolling of the tire can be suppressed.

### Second Embodiment

The pneumatic tire 1 according to the second embodiment has a substantially similar configuration as that of the pneumatic tire according to the first embodiment but is characterized in that the linear conductive portion 50 is sewn into the tie rubber 22. Since the other configuration is the same as that for the first embodiment, description therefor will be omitted, and the same reference signs will be used.

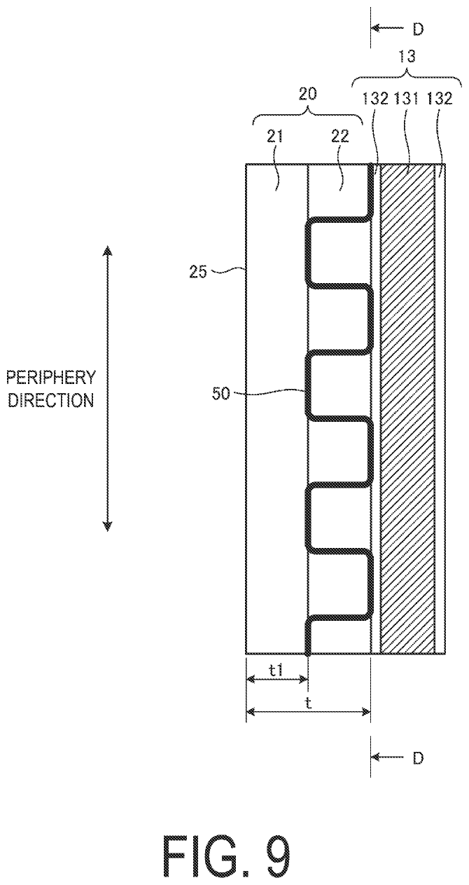

FIG. 9 is a cross-sectional view of a main portion illustrating an arrangement configuration of a linear conductive portion 50 in a pneumatic tire 1 according to a second embodiment. FIG. 9 is a detailed cross-sectional view of a case where the position at which the linear conductive portion 50 is disposed is seen in tire circumferential direction and, for example, is a detailed cross-sectional view of a position corresponding to the B part in FIG. 4 in the first embodiment. The pneumatic tire 1 according to the second embodiment has the linear conductive portion 50 extending continuously at least from the bead portion 10 to the belt layer 14 and disposed in the carcass inner rubber layer 20 similarly to the pneumatic tire 1 according to the first embodiment. In the second embodiment, unlike the first embodiment, the linear conductive portion 50 is sewn into the tie rubber 22 included in the carcass inner rubber layer 20.

Specifically, the linear conductive portion 50 is sewn into the tie rubber 22 in a manner that the linear conductive portion 50 extends in the periphery direction and repeatedly changes position between a face on the carcass layer 13 side and a face on the innerliner 21 side in the thickness direction of the tie rubber 22. That is, the linear conductive portion 50 is exposed on the tie rubber 22 on surfaces on the carcass layer 13 side and the innerliner 21 side of the tie rubber 22 in the thickness direction of the tie rubber 22.

Furthermore, the linear conductive portion 50 has a relationship between a thickness t of the carcass inner rubber layer 20 and a distance t1 from the tire inner surface 25 in a portion of the linear conductive portion 50 having a shortest distance from the tire inner surface 25 in at least a region on the outer side in the tire radial direction from the bead portion 10 satisfying 0.2≤t1/t≤0.8. In the second embodiment, because the linear conductive portion 50 is exposed on the surface of the innerliner 21 side of the tie rubber 22, the distance t1 of the linear conductive portion 50 from the tire inner surface 25 is substantially the same as the thickness of the innerliner 21.

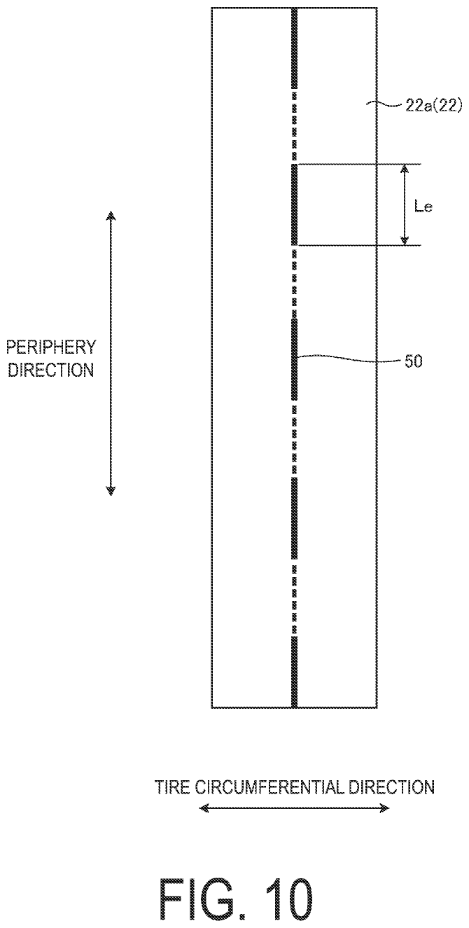

FIG. 10 is a D-D cross-sectional view of FIG. 9. In FIG. 10, the part of the linear conductive portion 50 exposed on the surface 22a of the tie rubber 22 is represented as a solid line, and the part of the linear conductive portion 50 that is not exposed on the surface 22a of the tie rubber 22 is represented by a dashed line. The linear conductive portion 50 exposed on the surface 22a of the tie rubber 22 has an exposure length Le on the surface 22a of the tie rubber 22 within a range of 1 mm or more and 30 mm or less. As described above, the linear conductive portion 50 disposed in the carcass inner rubber layer 20 is sewn into the tie rubber 22 while the length Le of 1 mm or more and 30 mm or less of the linear conductive portion 50 is exposed on the surface 22a of the tie rubber 22.

In the second embodiment, because the linear conductive portion 50 is sewn into the tie rubber 22, the linear conductive portion 50 can suppress the movement of the tie rubber 22 during deformation of the pneumatic tire 1 caused by driving of a vehicle in which the pneumatic tire 1 has been installed. Accordingly, even in a case where the carcass inner rubber layer 20, in which the linear conductive portion 50 is disposed, is deformed along with the deformation of the pneumatic tire 1, rubbing of the linear conductive portion 50 by the tie rubber 22 can be suppressed as much as possible. Accordingly, breakage of the linear conductive portion 50 due to rubbing of the linear conductive portion 50 by the tie rubber 22 can be suppressed, and the conductive path between the bead portion rubber 30 and the belt layer 14 can be more reliably ensured by the linear conductive portion 50 even after travel. As a result, the tire electrical resistance after travel can be more reliably maintained.

Because the linear conductive portion 50 has a relationship between the thickness t of the carcass inner rubber layer 20 and the distance t1 of the linear conductive portion 50 from the tire inner surface 25 satisfying 0.2≤t1/t≤0.8, the conductive path between the bead portion rubber 30 and the belt layer 14 can be reliably ensured even after travel. In other words, in a case where the relationship between the thickness t of the carcass inner rubber layer 20 and the distance t1 of the linear conductive portion 50 from the tire inner surface 25 is t1/t<0.2, the linear conductive portion 50 and the tire inner surface 25 are too close, and thus air on the tire inner cavity side may escape to the carcass layer 13 side from a position where the rubber between the linear conductive portion 50 and the tire inner surface 25 is thin. In this case, because the air pressure of the pneumatic tire 1 decreases, the amount of deformation of the tire during travel becomes larger, and thus the linear conductive portion 50 is less likely to be broken due to rubbing of the linear conductive portion 50 by the carcass inner rubber layer 20, and thus the conductive path by the linear conductive portion 50 may be difficult to be ensured. In a case where the relationship between the thickness t of the carcass inner rubber layer 20 and the distance t1 of the linear conductive portion 50 from the tire inner surface 25 is t1/t>0.8, because the distance between the linear conductive portion 50 and the carcass cord 131 is too small, the linear conductive portion 50 tends to be rubbed by the carcass cords 131 due to the deformation of the carcass cords 131 along with the tire deformation during travel. In this case, the linear conductive portion 50 is prone to breakage, the conductive path by the linear conductive portion 50 may be difficult to be ensured.

In contrast, in a case where the relationship between the thickness t of the carcass inner rubber layer 20 and the distance t1 of the linear conductive portion 50 from the tire inner surface 25 satisfies 0.2≤t1/t≤0.8, it is possible to prevent the linear conductive portion 50 from being readily rubbed by the carcass cords 131 and to prevent the linear conductive portion 50 from being readily rubbed by the carcass inner rubber layer 20 due to increase in the amount of deformation of the tire caused by the air escaping from the tire inner cavity side. Accordingly, breakage of the linear conductive portion 50 can be suppressed, and the conductive path between the bead portion rubber 30 and the belt layer 14 can be more reliably ensured by the linear conductive portion 50 even after travel. As a result, the tire electrical resistance after travel can be more reliably maintained.

Because the linear conductive portion 50 is sewn into the tie rubber 22 while the length of 1 mm or more and 30 mm or less of the linear conductive portion 50 is exposed on the surface 22a of the tie rubber 22, the conductive path by the linear conductive portion 50 can be more reliably ensured even after travel. In other words, in a case where the length Le of exposure of the linear conductive portion 50 on the surface 22a of the tie rubber 22 is less than 1 mm, because the stitching interval of the linear conductive portion 50 is too small, it may be difficult to sew the linear conductive portion 50 on the tie rubber 22. In a case where the length Le of exposure of the linear conductive portion 50 on the surface 22a of the tie rubber 22 is longer than 30 mm, because the stitching interval of the linear conductive portion 50 is too long, even when the linear conductive portion 50 is sewn into the tie rubber 22, it may be difficult to effectively suppress movement of the tie rubber 22. In this case, it becomes difficult to suppress rubbing of the linear conductive portion 50 and the tie rubber 22 during deformation of the tire, and it may be difficult to suppress breakage of the linear conductive portion 50 due to rubbing of the linear conductive portion 50 and the tie rubber 22. In a case where the length Le of exposure of the linear conductive portion 50 on the surface 22a of the tie rubber 22 is longer than 30 mm, because the stitching interval of the linear conductive portion 50 is too long, the linear conductive portion 50 may be prone to breakage due to rubbing between the portion of the linear conductive portion 50 exposed on the surface 22a of the tie rubber 22 and the carcass cords 131.

In contrast, in a case where the linear conductive portion 50 is sewn into the tie rubber 22 in a manner that the length Le of exposure of the linear conductive portion 50 on the surface 22a of the tie rubber 22 is 1 mm or more and 30 mm or less, sewing of the linear conductive portion 50 on the tie rubber 22 is facilitated, movement of the tie rubber 22 is effectively suppressed by the linear conductive portion 50, and the rubbing of the linear conductive portion 50 by the carcass cords 131 can be also suppressed. Thus, breakage of the linear conductive portion 50 due to rubbing of the linear conductive portion 50 by the tie rubber 22 caused by movement of the tie rubber 22 during travel and breakage of the linear conductive portion 50 due to rubbing of the linear conductive portion 50 by the carcass cords 131 can be suppressed, and the conductive path between the bead portion rubber 30 and the belt layer 14 can be more reliably ensured by the linear conductive portion 50 even after travel. As a result, the tire electrical resistance after travel can be more reliably maintained.

### Modified Examples

In the first embodiment described above, the carcass inner rubber layer 20 and the linear conductive portion 50 are disposed between the bead portion rubber 30 and the bead core 11 in a position of the bead portion 10; however, the carcass inner rubber layer 20 and the linear conductive portion 50 may be disposed at a position other than this position in the position of the bead portion 10.

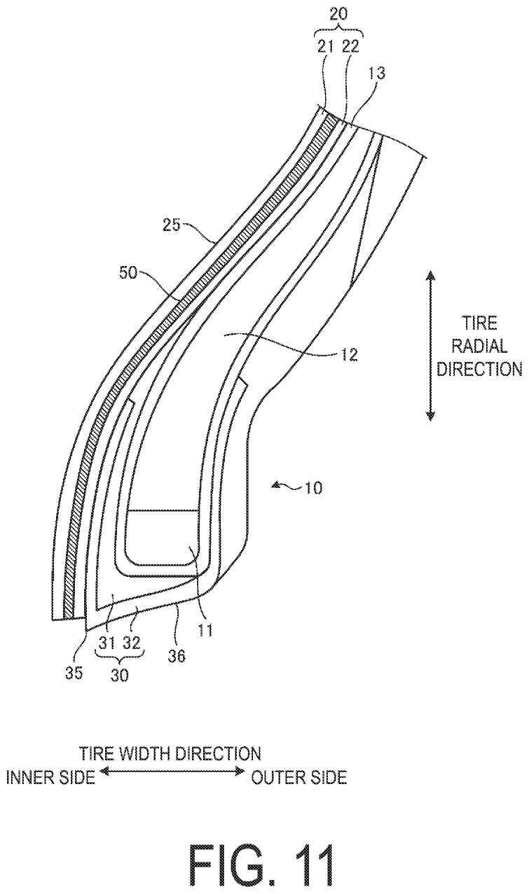

FIG. 11 is a modified example of a pneumatic tire 1 according to the first embodiment and is an explanatory diagram illustrating a case where a carcass inner rubber layer 20 and a linear conductive portion 50 are positioned on an inner side in the tire width direction of a bead portion rubber 30. The carcass inner rubber layer 20 may be positioned on the inner side of the bead portion rubber 30 in the tire width direction at a position in the bead portion 10 as illustrated in FIG. 11, for example. In the modified example illustrated in FIG. 11, an end portion on the inner side in the tire radial direction of the carcass inner rubber layer 20 is positioned in the vicinity of the bead toe 35. Because of this, the linear conductive portion 50 disposed on the carcass inner rubber layer 20 is positioned in the vicinity of the bead toe 35 on the outer side in the tire radial direction of the bead toe 35 at a position of the bead portion 10. Thus, the linear conductive portion 50 and the carcass inner rubber layer 20 overlap with the bead portion rubber 30 at a position in the bead portion 10.

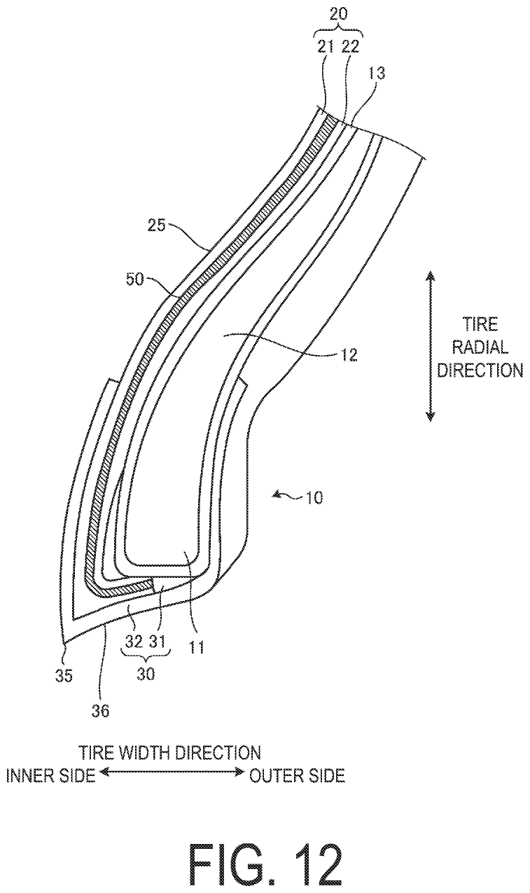

FIG. 12 is a modified example of a pneumatic tire 1 according to the first embodiment and is an explanatory diagram in a case where a linear conductive portion 50 is also disposed on a bead base 36 side. As illustrated in FIG. 12, the linear conductive portion 50 disposed in the carcass inner rubber layer 20 may extend from the tire inner surface 25 side beyond the bead toe 35 of the bead portion 10 to the bead base 36 at a position on the bead core 11 side with respect to the chafer 32 disposed in the bead portion 10. That is, in the modified example illustrated in FIG. 12, similarly to the first embodiment described above, the carcass inner rubber layer 20 is disposed from a position on the outer side in the tire width direction of a portion positioned on the inner side of the bead core 11 in the tire width direction at the chafer 32 in the bead portion rubber 30 to a position on the inner side of the bead core 11 in the tire radial direction, at a position in the bead portion 10.

In the modified example illustrated in FIG. 12, similarly to the carcass inner rubber layer 20, the linear conductive portion 50 is also disposed from a position on the outer side in the tire width direction of a portion positioned on the inner side of the bead core 11 in the tire width direction at the chafer 32 in the bead portion rubber 30 to a position on the inner side of the bead core 11 in the tire radial direction. Accordingly, in the modified example illustrated in FIG. 12, both the carcass inner rubber layer 20 and the linear conductive portion 50 extend beyond the position of the bead toe 35 to the bead base 36 side at a position on the bead core 11 side with respect to the chafer 32 and overlap with the bead portion rubber 30.

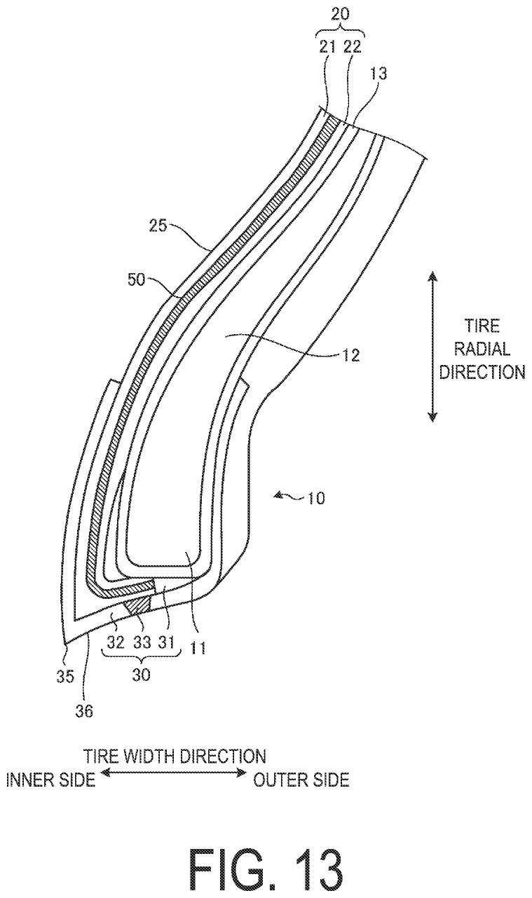

In the first embodiment described above, although the bead portion rubber 30 includes the rim cushion rubber 31 and the chafer 32, the bead portion rubber 30 may also include a member having a volume resistivity of less than 1×10\hat{ }8 Ω·cm in addition to these. FIG. 13 is a modified example of a pneumatic tire 1 according to the first embodiment and is an explanatory diagram in a case where a conductive rubber 33 is disposed in a bead portion rubber 30. For example, as illustrated in FIG. 13, in the bead portion rubber 30, a conductive rubber 33 that is a rubber member having a volume resistivity of less than 1×10\hat{ }8 Ω·cm may be disposed in the chafer 32. The conductive rubber 33 illustrated in FIG. 13 is disposed communicating from the inner side to the outer side in the tire radial direction at a portion constituting the bead base 36 of the chafer 32. This allows, when the pneumatic tire 1 is mounted on a rim, the conductive rubber 33 to be in contact with the rim R. Thus, in a case where the conductive rubber 33 having a volume resistivity of less than 1×10\hat{ }8 Ω·cm is disposed in the bead portion rubber 30, the rim cushion rubber 31 and the chafer 32 are each not required to have a volume resistivity of less than 1×10\hat{ }8 Ω·cm.

Accordingly, in a case where the conductive rubber 33 is disposed in the chafer 32, similarly to the modified example illustrated in FIG. 12, the carcass inner rubber layer 20 and the linear conductive portion 50 are disposed extending beyond the position of the bead toe 35 to the bead base 36 side at a position on the bead core 11 side with respect to the chafer 32. Accordingly, the linear conductive portion 50 is disposed overlapping the conductive rubber 33 having a volume resistivity of less than 1×10\hat{ }8 Ω·cm in the bead portion rubber 30, and thus the electrical conductivity between the rim R and the linear conductive portion 50 can be ensured by the conductive rubber 33. Accordingly, the conductive path can be connected from the rim R to the linear conductive portion 50 through the conductive rubber 33, and thus flow of electricity can be more effectively facilitated, and the tire electrical resistance of the pneumatic tire 1 in new condition can be reduced.

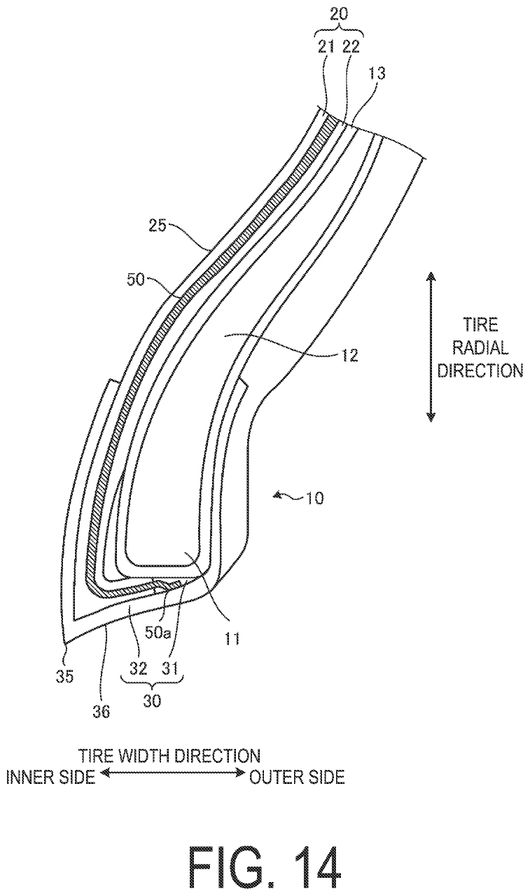

In the first embodiment described above, the linear conductive portion 50 is only disposed overlapping the bead portion rubber 30, and the linear conductive portion 50 may be in contact with the bead portion rubber 30. FIG. 14 is a modified example of a pneumatic tire 1 according to the first embodiment and is an explanatory diagram in a case where a linear conductive portion 50 is in contact with a chafer 32 of a bead portion rubber 30. For example, similarly to the modified example illustrated in FIG. 12, the linear conductive portion 50 may extend from the tire inner surface 25 side to at least the bead base 36 beyond the bead toe 35 of the bead portion 10 at a position on the bead core 11 side with respect to the chafer 32, and may be in contact with the bead portion rubber 30 at a position on the bead base 36 side with respect to the bead toe 35 as illustrated in FIG. 14. That is, the linear conductive portion 50 may include a contact portion 50a that is in contact with the bead portion rubber 30. Specifically, in the modified example illustrated in FIG. 14, the linear conductive portion 50 disposed in the carcass inner rubber layer 20 includes a contact portion 50a that came out from the carcass inner rubber layer 20 at a position overlapping a portion constituting the bead base 36 at the chafer 32 and is in contact with the chafer 32 included in the bead portion rubber 30.

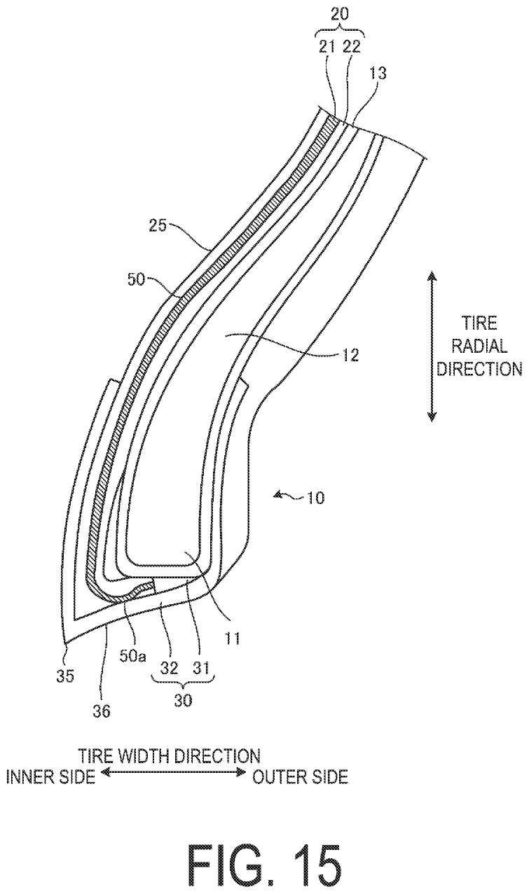

FIG. 15 is a modified example of a pneumatic tire 1 according to the first embodiment and is an explanatory diagram in a case where a linear conductive portion 50 is in contact with a chafer 32 of a bead portion rubber 30. Alternatively, as illustrated in FIG. 15, the linear conductive portion 50 may have a contact portion 50a that is in contact with the bead portion rubber 30 by being partially disposed toward the chafer 32 side at a position in the carcass inner rubber layer 20 at a position overlapping a portion constituting the bead base 36 at the chafer 32 in the carcass inner rubber layer 20.

The linear conductive portion 50 including the contact portion 50a that is in contact with the bead portion rubber 30 as described above allows the conductive path between the linear conductive portion 50 and the bead portion rubber 30 to be ensured and thus the conductive path from the rim R to the linear conductive portion 50 through the bead portion rubber 30 to be ensured. Accordingly, electricity can be more effectively passed, and the tire electrical resistance in new condition can be further reduced. Because the linear conductive portion 50 has a contact portion 50a that is in contact with the bead portion rubber 30 in a region extending beyond the bead toe 35 to the bead base 36, the linear conductive portion 50 can be in contact with the bead portion rubber 30 while possibility of air leakage is suppressed. As a result, the tire electrical resistance after travel can be more reliably maintained.

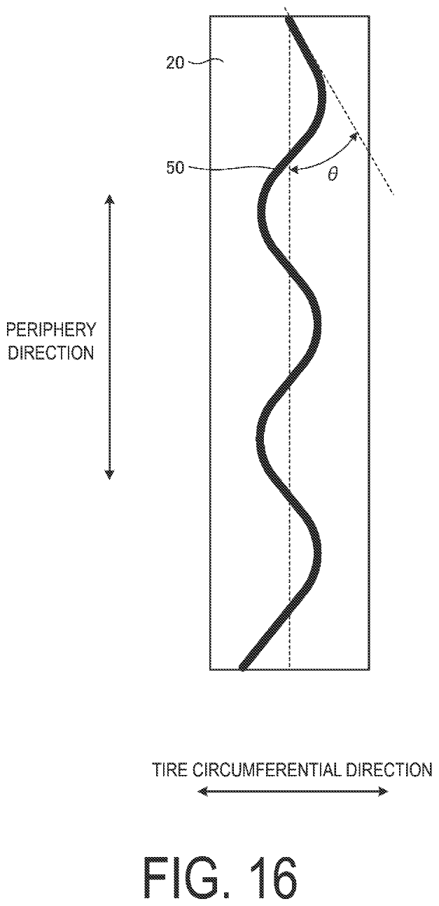

In the first embodiment described above, the linear conductive portion 50 extends in a direction along the periphery direction, and the linear conductive portion 50 may extend in a direction other than the periphery direction. FIG. 16 is a modified example of a pneumatic tire 1 according to the first embodiment and is an explanatory diagram in a case where a linear conductive portion 50 includes a portion inclining with respect to a periphery direction. The portion positioned on an inner side in the tire radial direction of the belt layer 14 and a portion positioned in the bead portion 10 of the linear conductive portion 50 each may include a portion inclining at an inclination angle θ of 300 or less in the tire circumferential direction with respect to the periphery direction. That is, the linear conductive portion 50 may extend along a substantially periphery direction in a portion positioned between the inner side of the belt layer 14 in the tire radial direction and the bead portion 10, and the portion positioned on an inner side in the tire radial direction of the belt layer 14 and a portion positioned in the bead portion 10 of the linear conductive portion 50 each may include a portion inclining in the tire circumferential direction with respect to the periphery direction.

For example, the linear conductive portion 50 may be formed in a wave shape curving in the tire circumferential direction while the linear conductive portion 50 extends in the periphery direction in each of the position on the inner side of the belt layer 14 in the tire radial direction and the position at the bead portion 10 as illustrated in FIG. 16. At this time, the linear conductive portion 50 formed in the wave shape preferably has an inclination angle θ in the tire circumferential direction with respect to the periphery direction of 30° or less. Accordingly, the tire electrical resistance of the pneumatic tire 1 in new condition can be reduced.

That is, the tire deformation during travel at a portion where the belt layer 14 is disposed and the bead portion 10 of the pneumatic tire 1 is made small and, even during travel, the linear conductive portion 50 is less likely to be rubbed by another member. Thus, by allowing the linear conductive portion 50 to incline in the tire circumferential direction while the linear conductive portion 50 extends in the periphery direction at the position on the inner side of the belt layer 14 in the tire radial direction and the position in the bead portion 10, the length of the overlapping between the linear conductive portion 50 and the belt layer 14 or the bead portion rubber 30 can be made longer while breakage of the linear conductive portion 50 due to rubbing of the linear conductive portion 50 by another member is suppressed. As a result, the tire electrical resistance of the pneumatic tire 1 in new condition can be reduced while the durability is ensured.

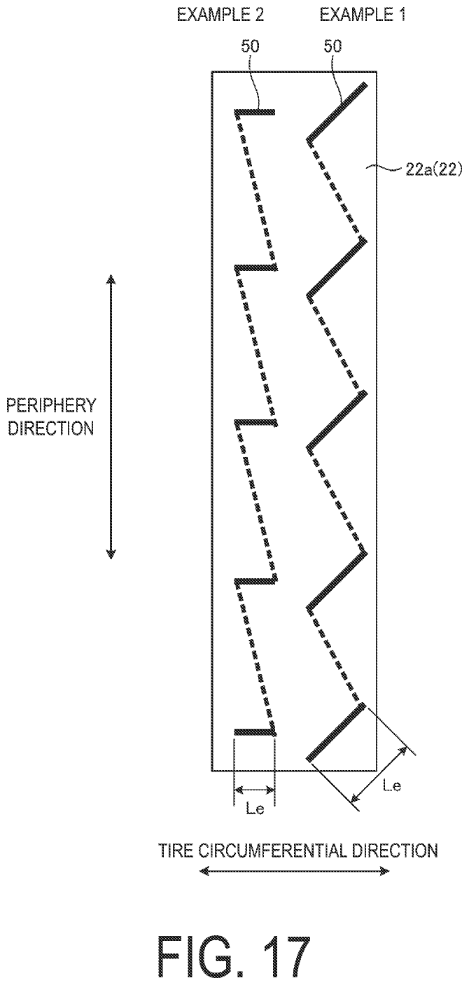

In the second embodiment described above, although the linear conductive portion 50 is sewn into the tie rubber 22 while extending in the periphery direction, the linear conductive portion 50 may be sewn into the tie rubber 22 while inclining with respect to the periphery direction. FIG. 17 is a modified example of a pneumatic tire 1 according to the second embodiment and is an explanatory diagram in a case where a linear conductive portion 50 is sewn into a tie rubber 22 while the linear conductive portion 50 is inclining in tire circumferential direction. FIG. 17 is an explanatory diagram illustrating the condition when the carcass inner rubber layer 20 is seen from the surface 22a on the tie rubber 22 side, which is the same direction as for the D-D cross-section of FIG. 9. The linear conductive portion 50 is sewn into the tie rubber 22 in the carcass inner rubber layer 20 while repeatedly inclining in the tire circumferential direction with respect to the periphery direction, and thus the portion of the linear conductive portion 50 exposed on the surface 22a of the tie rubber 22 may incline with respect to the tire circumferential direction as illustrated in FIG. 17.

That is, the linear conductive portion 50 is sewn into the tie rubber 22 while swinging in the tire circumferential direction with respect to the periphery direction, and thus the portion of the linear conductive portion 50 exposed on the surface 22a of the tie rubber 22 may incline with respect to both the periphery direction and the tire circumferential direction as illustrated in Example 1 in FIG. 17. Alternatively, the linear conductive portion 50 is sewn into the tie rubber 22 while swinging in the tire circumferential direction with respect to the periphery direction, and thus the portion of the linear conductive portion 50 exposed on the surface 22a of the tie rubber 22 may incline at approximately 90° with respect to the periphery direction and extend in the tire circumferential direction as illustrated in Example 2 in FIG. 17. When the linear conductive portion 50 is sewn into the tie rubber 22 of the carcass inner rubber layer 20, the linear conductive portion 50 is preferably sewn in a manner that exposure of the linear conductive portion 50 on the surface 22a of the tie rubber 22 is in the length Le of 1 mm or more and 30 mm or less regardless of the angle of the portion exposed on the surface 22a of the tie rubber 22.

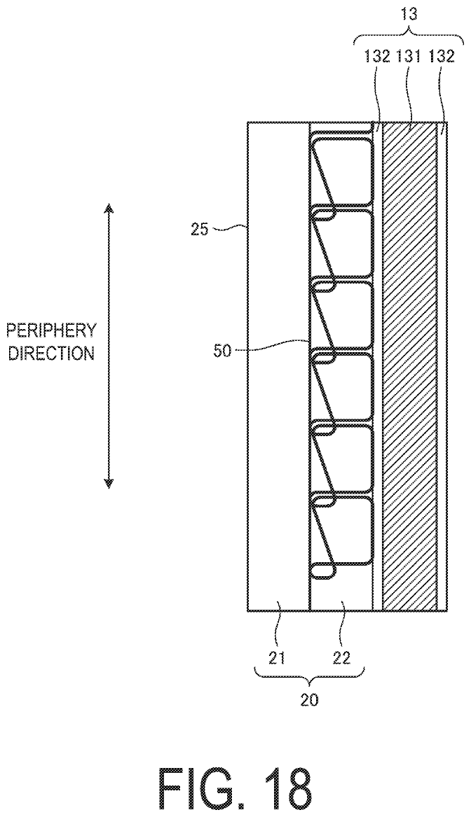

In the second embodiment described above, the linear conductive portion 50 is sewn into the tie rubber 22 by disposing the linear conductive portion 50 by repeatedly moving between both faces in the thickness direction of the tie rubber 22 while extending in the periphery direction; however, the linear conductive portion 50 may be sewn into the tie rubber 22 in the form other than this form. FIG. 18 is a modified example of a pneumatic tire 1 according to the second embodiment and is an explanatory diagram in a case where a linear conductive portion 50 is braided into a tie rubber 22. For example, as illustrated in FIG. 18, linear conductive portions 50 may interlock each other and braided in the tie rubber 22 by repeatedly moving between both faces in the thickness direction of the tie rubber 22 while extending in the periphery direction and also repeatedly moving in the periphery direction. Because the linear conductive portion 50 is braided into the tie rubber 22, the linear conductive portion 50 can more reliably suppress the movement of the tie rubber 22 during deformation of the pneumatic tire 1 caused by driving a vehicle in which the pneumatic tire 1 has been installed.

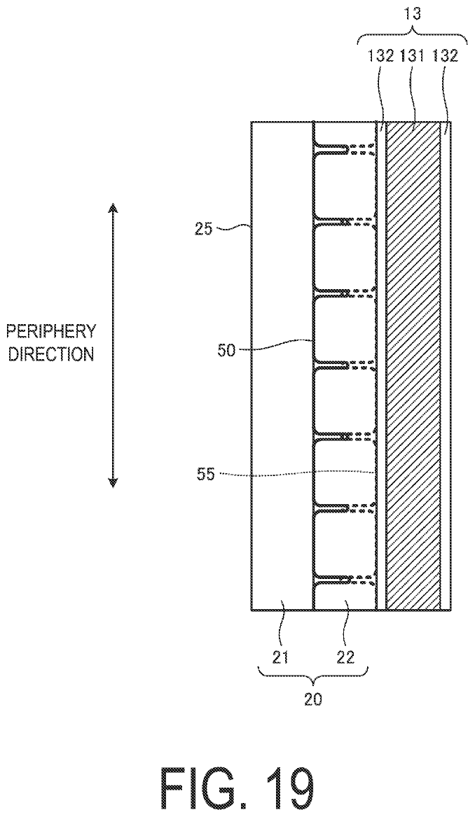

The linear conductive portion 50 may be sewn into the tie rubber using another member. FIG. 19 is a modified example of a pneumatic tire 1 according to the second embodiment and is an explanatory diagram in a case where a linear conductive portion 50 is sewn into a tie rubber 22 by also using a linear non-conductive portion 55. In FIG. 19, the linear non-conductive portion 55 is represented by a dashed line to distinguish the linear conductive portion 50 and the linear non-conductive portion 55. For example, as illustrated in FIG. 19, the linear conductive portion 50 may be sewn into the tie rubber 22 by also using the linear non-conductive portion 55. The linear non-conductive portion 55 in this case is a linear member having a volume resistivity of 1×10\hat{ }8 Ω·cm or more. In the modified example illustrated in FIG. 19, the linear conductive portion 50 is sewn from a face side on the innerliner 21 side of the tie rubber 22, and the linear non-conductive portion 55 is sewn from a face side of the carcass layer 13 side of the tie rubber 22, and thus the linear conductive portion 50 is sewn into the tie rubber 22 by interlocking of the linear conductive portion 50 and the linear non-conductive portion 55 in the tie rubber 22.

Because the linear conductive portion 50 is sewn into the tie rubber 22 by the interlocking with the linear non-conductive portion 55 sewn from the face side of the carcass layer 13 side of the tie rubber 22, the linear conductive portion 50 can be sewn into the tie rubber 22 while the distance between the linear conductive portion 50 and the carcass cord 131 is made large. Accordingly, by suppressing movement of the tie rubber 22 at the time of deformation of the pneumatic tire 1 by the linear conductive portion 50, rubbing of the linear conductive portion 50 by the carcass cords 131 can be suppressed while rubbing of the linear conductive portion 50 by the tie rubber 22 is suppressed. Accordingly, at the time of deformation of the pneumatic tire 1, breakage of the linear conductive portion 50 due to rubbing of the linear conductive portion 50 by the tie rubber 22 and rubbing of the linear conductive portion 50 by the carcass cords 131 can be suppressed, and the conductive path between the bead portion rubber 30 and the belt layer 14 can be more reliably ensured by the linear conductive portion 50 even after travel. As a result, the tire electrical resistance after travel can be more reliably maintained.

In the first embodiment described above, the linear conductive portion 50 is disposed inside the carcass inner rubber layer 20 without being exposed on the tire inner surface 25; however, part of the linear conductive portion 50 may be exposed on the tire inner surface 25. Not less than 60% of the length of the linear conductive portion 50 in the extension direction is preferably disposed in the carcass inner rubber layer 20 without being exposed on the tire inner surface 25.

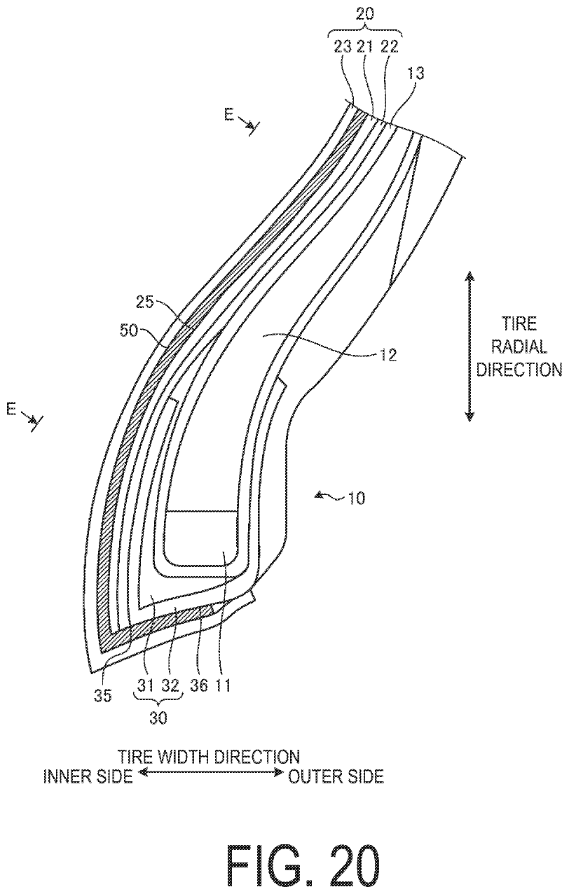

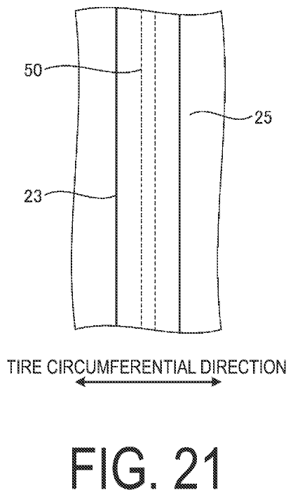

In the first embodiment described above, the carcass inner rubber layer 20 in which the linear conductive portion 50 is disposed is formed by layering the innerliner 21 and the tie rubber 22; however, the carcass inner rubber layer 20 may use a member other than the innerliner 21 and the tie rubber 22. FIG. 20 is an explanatory diagram of a modified example of the pneumatic tire 1 according to the first embodiment in a case where a carcass inner rubber layer 20 includes a cover rubber layer 23. FIG. 21 is a view in the direction of arrows E-E in FIG. 20. For example, as illustrated in FIGS. 20 and 21, the carcass inner rubber layer 20 may include a cover rubber layer 23 besides the innerliner 21 and the tie rubber 22. In this case, the linear conductive portion 50 is disposed on a face on the tire inner cavity side of the innerliner 21, i.e., on a face on a side opposite to a face of the tie rubber 22 side of the innerliner 21, and the cover rubber layer 23 is disposed covering the linear conductive portion 50 from the tire inner cavity side. The cover rubber layer 23, which is a member constituting the carcass inner rubber layer 20 and is disposed covering the linear conductive portion 50, is a band-like member made of a rubber material.

The band-like cover rubber layer 23 extends along the linear conductive portion 50 in a substantially periphery direction and covers the linear conductive portion 50 over the entire region in the length direction of the linear conductive portion 50 disposed on the innerliner 21. In other words, in the modified example illustrated in FIGS. 20 and 21, in the carcass inner rubber layer 20, the cover rubber layer 23 is the first layer, the innerliner 21 is the second layer, and the linear conductive portion 50 is disposed between the cover rubber layer 23 that is the first layer and the innerliner 21 that is the second layer. Accordingly, the linear conductive portion 50 is disposed in the carcass inner rubber layer 20.

The linear conductive portion 50 is disposed in the carcass inner rubber layer 20 as described above, and thus rubbing of the linear conductive portion 50 by the carcass layer 13 is less likely to occur at the time of deformation of the pneumatic tire 1, and thus breakage of the linear conductive portion 50 can be suppressed. Thus, the conductive path between the bead portion rubber 30 and the belt layer 14 can be ensured by the linear conductive portion 50 even after the pneumatic tire 1 traveled for a long distance, and the tire electrical resistance after travel can be maintained.

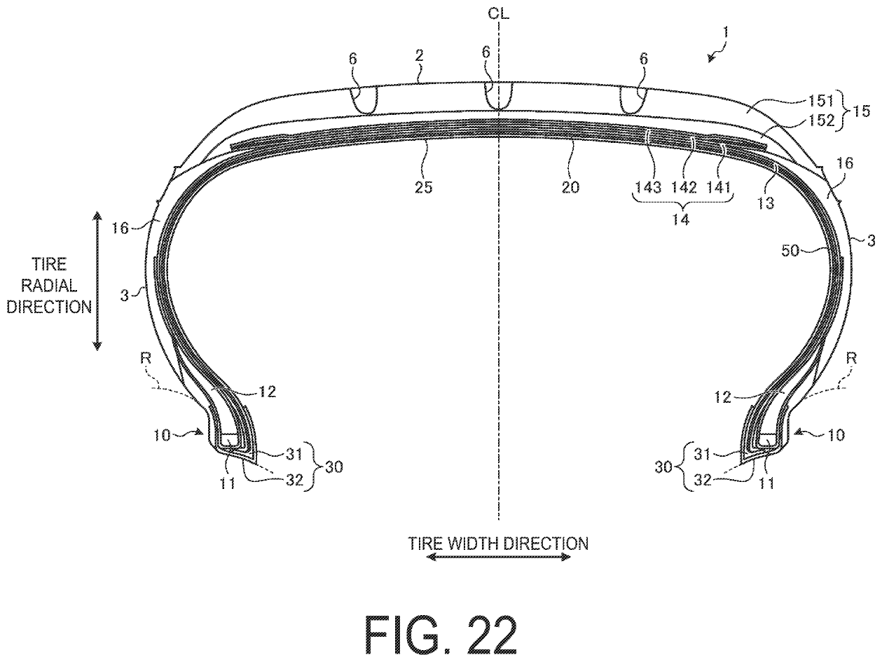

Furthermore, although the linear conductive portion 50 is disposed on one side of the tire equatorial plane CL in the tire width direction in the first embodiment described above, the linear conductive portion 50 may be disposed on both sides of the tire equatorial plane CL in the tire width direction. FIG. 22 is a modified example of a pneumatic tire 1 according to the first embodiment and is an explanatory diagram in a case where a linear conductive portion 50 is disposed extending to both sides in a tire width direction. For example, the linear conductive portion 50 may be disposed on both sides in the tire width direction as illustrated in FIG. 22. That is, the linear conductive portion 50 may be continuously disposed from one bead portion 10 side to the other bead portion 10 sides for the bead portions 10 positioned on both sides of in the tire width direction.

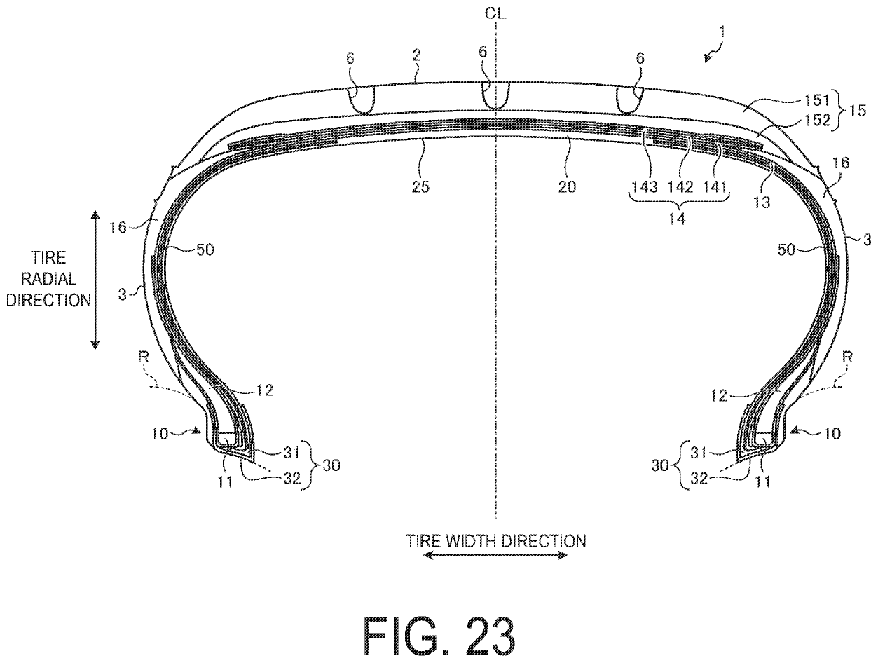

FIG. 23 is a modified example of a pneumatic tire 1 according to the first embodiment and is an explanatory diagram in a case where a linear conductive portion 50 is disposed extending to both sides in a tire width direction. Furthermore, as illustrated in FIG. 23, the linear conductive portions 50 may be disposed, each independently, extending from a position in the bead portion 10 to a position in the belt layer 14 in regions on both sides of the tire equatorial plane CL in the tire width direction. In this case, the lap widths La (see FIG. 3) of the linear conductive portions 50 with respect to the belt layer 14 may be an identical size for the linear conductive portions 50 disposed on both sides in the tire width direction or may be sizes that are different each other.

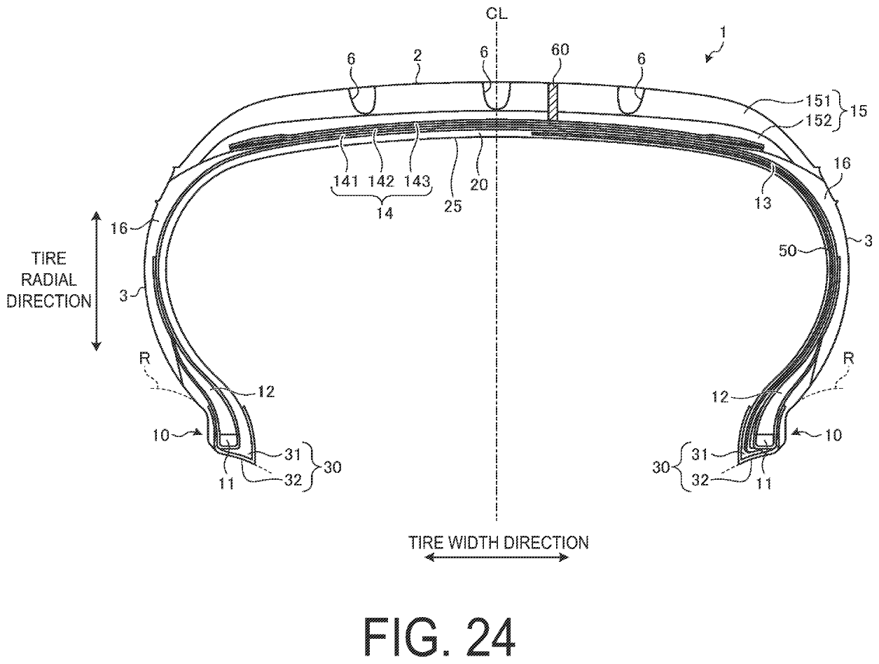

In the first embodiment described above, although the linear conductive portion 50 is used as the electrostatic suppressing structure to discharge static electricity generated in a vehicle during traveling of the vehicle to a road surface, the electrostatic suppressing structure may include an additional member besides the linear conductive portion 50. FIG. 24 is a modified example of a pneumatic tire 1 according to the first embodiment and is an explanatory diagram in a case where an earthing tread 60 is disposed. For example, the earthing tread 60 may be used in the electrostatic suppressing structure to discharge static electricity generated in a vehicle to a road surface as illustrated in FIG. 24. The earthing tread 60 in this case is a conductive rubber embedded in the tread rubber 15 and exposed to the tire ground contact surface. In the electrostatic suppressing structure including the linear conductive portion 50 and the earthing tread 60, static electricity from the vehicle allowed to flow to the belt layer 14 by the linear conductive portion 50 is discharged from the belt layer 14 to the road surface via the earthing tread 60, and thus electrostatic charging in the vehicle is suppressed.

For details, the earthing tread 60 is exposed to the road contact surface of the tread rubber 15, is disposed passing through the cap tread 151 and the undertread 152, and is in contact with the belt layer 14 in a conductive manner. That is, the earthing tread 60 is at least disposed passing through the cap tread 151 and exposed to the tire ground contact surface. In the modified example illustrated in FIG. 24, the earthing tread 60 is disposed passing through the cap tread 151 and the undertread 152, and an end portion on the inner side in the tire radial direction is in contact with the belt cover 143 in a conductive manner. Consequently, a conductive path is secured from the belt layer 14 to the road surface.

In addition, the earthing tread 60 has an annular structure extending around the entire circumference of the tire. A portion of the earthing tread 60 is exposed to the tread contact surface and extends continuously in the tire circumferential direction. Thus, during rolling of the pneumatic tire 1, a conductive path from the belt layer 14 to the road surface is always ensured by the earthing tread 60 being always in contact with the road surface. In the modified example illustrated in FIG. 24, the width of the earthing tread 60 in the tire width direction is narrower than the groove width of the circumferential main groove 6 extending in the tire circumferential direction on the tread portion 2, and the earthing tread 60 is formed between circumferential main grooves 6 that are adjacent in the tire width direction.

The earthing tread 60 is made of conductive rubber material having a lower volume resistivity than the tread rubber 15. Specifically, the earthing tread 60 preferably has a volume resistivity of less than 1×10\hat{ }8 Ω·cm, and more preferably of 1×10\hat{ }6 Ω·cm or less.

Configuring the electrostatic suppressing structure using the earthing tread 60 in addition to the linear conductive portion 50 as described above allows a path from the rim R through the bead portion rubber 30, the linear conductive portion 50, and the belt layer 14 to the earthing tread 60 to be used as a conductive path to discharge static electricity from a vehicle to a road surface. In other words, since the earthing tread 60 is at least disposed passing through the cap tread 151 and exposed to the tire ground contact surface as well as having a volume resistivity of less than 1×10\hat{ }8 Ω·cm, a conductive path from the belt layer 14 side to a road surface can be ensured by the earthing tread 60. Accordingly, the conductive path from the linear conductive portion 50 to the road surface can be ensured, and thus the conductive path from the rim R to the earthing tread 60 can be more reliably ensured. Thus, the electrical resistance between the rim R and the road surface can be more reliably reduced, and static electricity generated in the vehicle can be more reliably discharged to the road surface. As a result, the electrostatic suppression performance can be more reliably ensured.

By providing the earthing tread 60, degradation in the electrostatic suppression performance can be suppressed in a case where a silica content in a rubber compound constituting the cap tread 151, the undertread 152, the sidewall rubber 16, or the like is increased to improve fuel efficiency by reducing rolling resistance of the pneumatic tire 1. In other words, since silica has high insulating characteristics, when the silica content of the cap tread 151 is increased, a volume resistance value of the cap tread 151 increases and the electrostatic suppression performance decreases; however, by providing the earthing tread 60, the conductive path between the belt layer 14 and a road surface can be ensured. As a result, the electrostatic suppression performance can be ensured in a case where rolling resistance is reduced.

In the first embodiment described above, in the carcass inner rubber layer 20, the innerliner 21 and the tie rubber 22 are disposed in the same range in the periphery direction; however, in the carcass inner rubber layer 20, the innerliner 21 and the tie rubber 22 may be disposed in different regions. For example, the tie rubber 22 may be disposed in part of a region where the innerliner 21 is disposed. In this case, the tie rubber 22 is disposed in a portion with a large deformation at the time of deformation of the pneumatic tire 1 of the carcass inner rubber layer 20, and the linear conductive portion 50 is preferably disposed between the innerliner 21 and the tie rubber 22 or sewn into the tie rubber 22 in a portion where the tie rubber 22 is disposed in the carcass inner rubber layer 20. In this manner, the tie rubber 22 is disposed in a portion with a large deformation in the carcass inner rubber layer 20, the linear conductive portion 50 is disposed in the carcass inner rubber layer 20, thus rubbing of the linear conductive portion 50 by the carcass cords 131 can be suppressed, and breakage of the linear conductive portion 50 can be suppressed.

As described above, the method of producing the pneumatic tire 1 in which the linear conductive portion 50 is disposed in the carcass inner rubber layer 20 may be performed by using a member obtained by disposing the linear conductive portion 50 between a plurality of rubber layers constituting the carcass inner rubber layer 20 as in the first embodiment, or may be performed by using a member in which the linear conductive portion 50 has been sewn into one of a plurality of rubber layers constituting the carcass inner rubber layer 20 as in the second embodiment. Similarly to the modified example illustrated in FIGS. 20 and 21, production may be performed by adhering the linear conductive portion 50 to the tire inner surface 25 in the carcass inner rubber layer 20 after tire formation by using an adhesive or the like, and adhering the cover rubber layer 23 in the tire inner surface 25 so that the cover rubber layer 23 covers the linear conductive portion 50. As long as at least part of the linear conductive portion 50 is disposed in the carcass inner rubber layer 20, the method of producing the pneumatic tire 1 is not limited.

### Examples

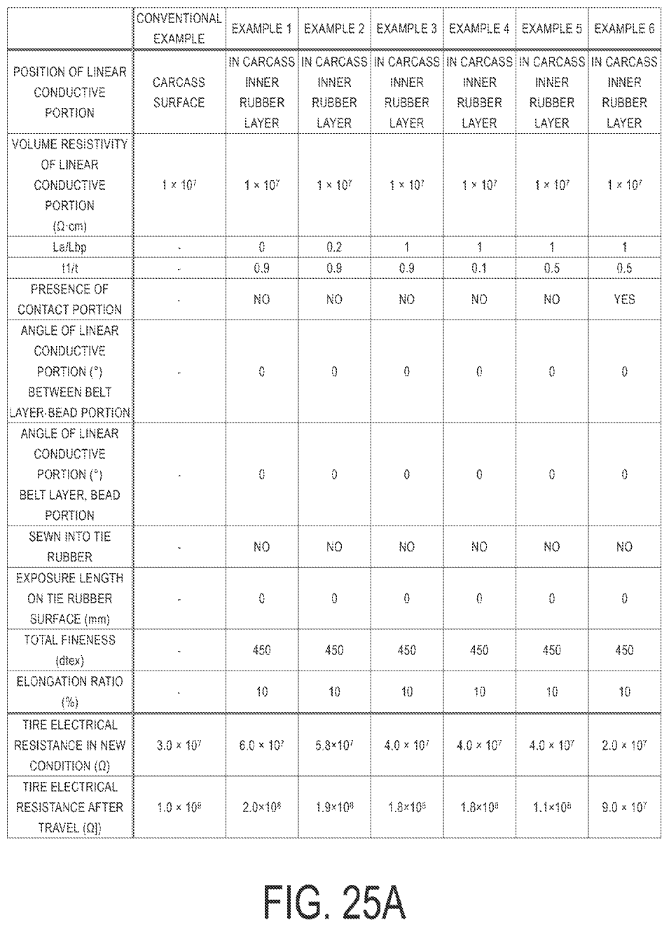

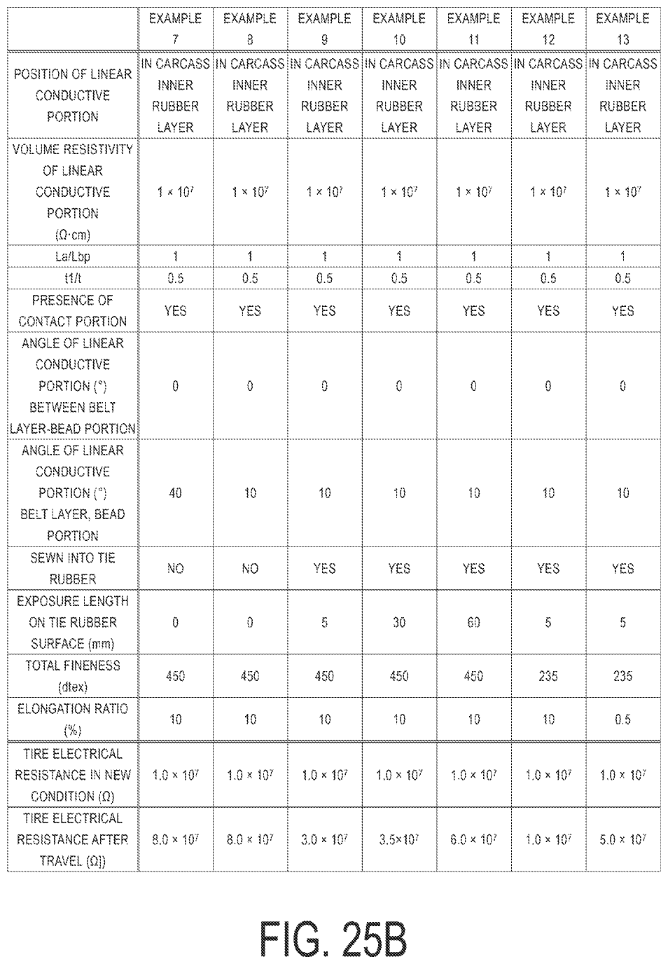

FIGS. 25A and 25B are tables showing results of performance evaluation tests of pneumatic tires. Hereinafter, evaluation tests of performance of the pneumatic tire 1 described above performed on pneumatic tires of Conventional Examples and the pneumatic tires 1 according to the embodiments of the present technology will be described. The performance evaluation tests were performed for electrical resistances in new condition and after travel of the pneumatic tire 1.

The performance evaluation tests were performed by using the pneumatic tire having a tire nominal size of 195/65R15 91H specified by JATMA as a test tire. The evaluation test for electrical resistance of the test tire in new condition was performed by measuring electrical resistance [Ω] of the test tire by using R8340A ultra high resistance meter, available from Advantest Corporation, in accordance with measurement conditions specified by JATMA.

The evaluation test for electrical resistance of the test tire after travel was measured as follows.
the test tires were mounted on applicable rims as specified by JATMA,
inflated to an air pressure of 200 kPa,
loaded with 80% of a maximum load as specified by JATMA, and
run for 60 minutes at a speed of 81 km/h using an indoor drum type tire rolling resistance tester with a drum diameter of 1707 mm, and then
the electrical resistance [Ω] of the test tire was measured by using R8340A ultra high resistance meter, available from Advantest Corporation, in accordance with measurement conditions specified by JATMA. A smaller measured value of the tire electrical resistance in new condition or after travel indicates lower electrical resistance and superior performance of tire electrical resistance.

The performance evaluation tests were performed on 14 types of pneumatic tires including a pneumatic tire according to Conventional Example as an example of a known pneumatic tire, and Examples 1 to 13 corresponding to the pneumatic tires 1 according to embodiments of the present technology. Among these, in the pneumatic tire of Conventional Example, the linear conductive portion is disposed on a surface of the carcass.

In contrast, in Examples 1 to 13 that are each an example of the pneumatic tire 1 according to an embodiment of the present technology, all the linear conductive portions are disposed in the carcass inner rubber layer. In the pneumatic tire 1 according to Examples 1 to 13, the relationship (La/Lbp) between the width Lbp of the belt layer 14 in the periphery direction and the lap width La of the linear conductive portion 50 with respect to the belt layer 14, the relationship (t1/t) of the thickness t of the carcass inner rubber layer 20 and the distance t1 of the linear conductive portion 50 from the tire inner surface 25, presence of the contact portion 50a of the linear conductive portion 50, angle of the linear conductive portion 50, presence of sewing of the linear conductive portion 50 into the tie rubber 22, exposure length of the linear conductive portion 50 on the surface 22a of the tie rubber 22, total fineness of the linear conductive portion 50, and elongation ratio of the linear conductive portion 50 are varied.

As a result of performing the evaluation test using these pneumatic tires 1, as shown in FIGS. 25A and 25B, it was found that the pneumatic tires 1 according to Examples 1 to 13 can reduce tire electrical resistance after travel compared to Conventional Example. Thus, it was found that the pneumatic tire 1 according to each of Examples 1 to 13 can prevent excessive increase of the tire electrical resistance after travel with respect to the tire electrical resistance in new condition compared to Conventional Example, and change in the tire electrical resistances between the new condition and after travel is not large. In other words, the pneumatic tire 1 according to each of Examples 1 to 13 has the effect of maintaining tire electrical resistance after travel.

1-18. (canceled)

19. A tire, comprising:
a pair of bead portions;
at least one carcass layer extending between the pair of bead portions;
a belt layer disposed on an outer side of the carcass layer in a tire radial direction; and
a carcass inner rubber layer disposed on a tire inner cavity side with respect to the carcass layer;
the tire further comprising a linear conductive portion extending continuously at least from one of the bead portions to the belt layer and disposed on the carcass inner rubber layer; and
the linear conductive portion being at least partially positioned in the carcass inner rubber layer and having a volume resistivity of less than 1×10\hat{ }8 Ω·cm.

20. The tire according to claim 19, wherein
the belt layer comprises one or more belt plies extending in a tire width direction,
in drawing lines from end portions on both sides in the tire width direction of a belt ply having a largest width in the tire width direction of the belt plies toward a tire inner surface, a periphery length between intersection points of the perpendicular lines and the tire inner surface is Lbp,
a length in a periphery direction of a portion positioned on an inner side in the tire radial direction of the belt layer of the linear conductive portion is La, and
the linear conductive portion satisfies 0.01≤La/Lbp≤1.

21. The tire according to claim 19, wherein the linear conductive portion has a relationship between a thickness t of the carcass inner rubber layer and a distance t1 from the tire inner surface in a portion of the linear conductive portion having a shortest distance from the tire inner surface in at least a region on an outer side in the tire radial direction from the bead portion satisfying 0.2≤t1/t≤0.8.

22. The tire according to claim 19, wherein
a bead portion rubber in contact with a rim flange is disposed in the bead portion,
the bead portion rubber has a volume resistivity of less than 1×10\hat{ }8 Ω·cm, and
the linear conductive portion includes a portion overlapping the bead portion rubber.

23. The tire according to claim 22, wherein
the linear conductive portion extends from the tire inner surface side to at least a bead base beyond a bead toe of the bead portion and is in contact with the bead portion rubber at a position on the bead base side from the bead toe.

24. The tire according to claim 19, wherein the linear conductive portion extends along the periphery direction in at least a region between the belt layer and the bead portion.

25. The tire according to claim 19, wherein a portion positioned on an inner side in the tire radial direction and a portion positioned in the bead portion of the belt layer of the linear conductive portion each include a portion inclining at an inclination angle of 30° or less in the tire circumferential direction with respect to the periphery direction.

26. The tire according to claim 19, wherein
the carcass inner rubber layer comprises a first layer and a second layer that are layered, and
at least part of the linear conductive portion is disposed between the first layer and the second layer.

27. The tire according to claim 26, wherein
the first layer is an innerliner, and
the second layer is a tie rubber.

28. The tire according to claim 27, wherein the linear conductive portion is sewn into the tie rubber.

29. The tire according to claim 28, wherein the linear conductive portion is sewn into the tie rubber, and a length of 1 mm or more and 30 mm or less of the linear conductive portion is exposed on a surface of the tie rubber.

30. The tire according to claim 19, wherein the linear conductive portion is made by intertwining a plurality of linear members including at least one conductive linear member having a volume resistivity of less than 1×10\hat{ }8 Ω·cm.

31. The tire according to claim 30, wherein the linear conductive portion is made by intertwining the conductive linear member and a non-conductive linear member having a volume resistivity of 1×10\hat{ }8 Ω·cm or more.

32. The tire according to claim 31, wherein
the conductive linear member is a metal fiber, and
the non-conductive linear member is an organic fiber.

33. The tire according to claim 30, wherein the conductive linear member is made by intertwining a plurality of carbon fibers.

34. The tire according to claim 30, wherein the conductive linear member is a monofilament cord made of a carbon fiber.

35. The tire according to claim 19, wherein the linear conductive portion has a total fineness of 20 dtex or more and 1000 dtex or less.

36. The tire according to claim 35, wherein the linear conductive portion has an elongation ratio of 1.0% or more and 70.0% or less.
